(19) United States
(12) Patent Application Publication
(10) Pub. No.: US 2010/0295844 A1
(43) Pub. Date: Nov. 25, 2010

(54) DISPLAY CONTROL APPARATUS AND DISPLAY CONTROL METHOD

(76) Inventor: Tsuneo HAYASHI, Chiba (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/774,830

(22) Filed: May 6, 2010

(30) Foreign Application Priority Data
May 19, 2009 (JP) P2009-120729

(51) Int. Cl. G09G 5/00

(52) U.S. Cl. 345/214

(57) ABSTRACT

A display control apparatus for controlling a display panel unit including a display unit having scanning lines and signal lines, a scanning line driving unit for selecting a horizontal line into which signals are written at the time of driving the signal lines by driving one of the scanning lines, and a signal line driving unit for causing the display unit to display an image by driving the signal lines on the basis of an input image signal includes a scanning control unit configured to control the scanning line driving unit so that adjacent scanning lines are simultaneously driven in a horizontal line period in which an image signal of one horizontal line is output and the same pixel value is written into adjacent pixels, and so that combinations of simultaneously driven scanning lines are changed in each period corresponding to a frame period of the input image signal.

### BACKGROUND OF THE INVENTION

1. Field of the Invention

The present invention relates to a display control apparatus and a display control method for controlling a display panel unit that includes a display unit having a plurality of scanning lines and a plurality of signal lines and performs image display.

2. Description of the Related Art

Flat-panel displays (hereinafter referred to as FPDs) such as liquid crystal displays, organic electroluminescence (EL) displays, plasma displays, field emission displays (FEDs) are widely used. A fixed pixel display method of fixedly arranging pixels in horizontal and vertical directions and performing image display is applied to FPDs.

The image quality of moving images displayed by FPDs is lower than that of moving images displayed by cathode ray tube (CRT) displays in the related art. It is therefore necessary to improve image quality in FPDs. For example, problems occurring at the time of displaying moving images include motion blurring and jerkiness that is recognized as multiple images. These problems arise from a low screen switching response speed. In particular, in the case of liquid crystal displays, these problems arise from hold-type display. In hold-type display, the same image is continuously displayed during a period of one frame, and a viewer determines that a displayed object moves and moves a line of sight in a movement direction of the object. Accordingly, the misalignment between an actual display position and a viewpoint position occurs. Such misalignments are accumulated on the retina of the viewer and are recognized as a blur.

The cause of moving image quality degradation such as motion blurring is a lack of time reproducibility at the time of displaying an image. Accordingly, an effective way to improve moving image quality is to improve time reproducibility by achieving a higher frame rate.

In order to achieve a higher frame rate, for example, a method of driving a plurality of adjacent scanning lines at the same time is performed as illustrated in FIG. 32. More specifically, although a single scanning line is usually driven in each period of one horizontal line, a plurality of scanning lines are driven at the same time in each period of one horizontal line in the method illustrated in FIG. 32. FIG. 32 illustrates a case in which two adjacent scanning lines are driven at the same time in each period of one horizontal line. That is, in this case, lines 0 and 1 are driven at the same time in a first horizontal line period, lines 2 and 3 are driven at the same time in a second horizontal line period, lines 4 and 5 are driven at the same time in a third horizontal line period, and lines 6 and 7 are driven at the same time in a fourth horizontal line period. The above-described operation is repeated.

By driving a plurality of scanning lines at the same time as described previously, a time necessary for scanning of one frame is reduced. As a result, a frame rate is increased. For example, in the case illustrated in FIG. 32, the time necessary for scanning of one frame is reduced to one half the normal time, and a frame rate can therefore be increased to double the normal frame rate.

Related arts include Japanese Unexamined Patent Application Publication Nos. 2007-212571 and 2007-286381.

### SUMMARY OF THE INVENTION

However, in the case illustrated in FIG. 32 in which a plurality of lines are driven at the same time so as to increase a frame rate, a viewer perceives light and dark stripes as illustrated in FIG. 33. More specifically, when the method of driving two lines at the same time, which has been described with reference to FIG. 32, is performed, darkness is perceived in an upper line included in each of combinations of two lines that are sequentially scanned and lightness is perceived in a lower line as illustrated in FIG. 33. Such a light and dark pattern is generated from a crosstalk between adjacent lines.

FIG. 34 is a diagram describing an example of a principle of occurrence of such a light and dark pattern (occurrence of a crosstalk). Referring to FIG. 34, a part of a pixel circuit formed on a display panel (pixels disposed at the intersections of horizontal lines 0 to 3 and two vertical lines) is illustrated. When combinations of two lines are sequentially scanned as described previously with reference to FIG. 32, first, lines 0 and 1 are driven at the same time. Subsequently, a switching element included in each pixel in the lines 0 and 1 is turned on, a signal value is written into the pixel, and a voltage corresponding to the signal value is stored in a capacitor included in the pixel. After the application of a driving voltage to the combination of the lines 0 and 1 has been stopped and the switching element included in each pixel in the lines 0 and 1 has been turned off, lines 2 and 3 are driven at the same time, a switching element included in each pixel in the lines 2 and 3 is turned on, and the writing of a signal value is similarly performed. By repeating the above-described operation, combinations of two lines are sequentially scanned.

At that time, if a parasitic capacitor is present between capacitors included in pixels that are adjacent to each other in a vertical direction, a writing voltage obtained when a signal value is written into the lines 2 and 3 at the time of scanning of the lines 2 and 3 after the scanning of the lines 0 and 1 enters the line 1 in which switching elements are in an OFF state. The writing voltage for the lines 2 and 3 also enters the line 0 in theory. However, since a voltage entering the line 0 that is farther from the lines 2 and 3 than the line 1 is significantly lower than that entering the line 1, it is possible to determine that the writing voltage for the lines 2 and 3 actually enters only the line 1. As a result, the line 0 is relatively dark and the line 1 is relatively light. The entering of a writing voltage from an adjacent line similarly occurs in each combination of lines. Consequently, when two lines are driven at the same time as described previously with reference to FIG. 32, the dark-light-dark pattern illustrated in FIG. 33 is generated.

As described previously, the method of increasing a frame rate (improving moving image quality) by driving a plurality of adjacent scanning lines at the same time in a period of one horizontal line generates a pattern of light and dark stripes on a displayed image. This leads to the degradation in image quality. The present invention provides a display control apparatus and a display control method capable of improving image quality without generating such a pattern of light and dark stripes when increasing a frame rate by driving a plurality of adjacent scanning lines at the same time in a period of one horizontal line.

A display control apparatus according to an embodiment of the present invention for controlling a display panel unit including a display unit having a plurality of scanning lines and a plurality of signal lines, a scanning line driving unit for selecting a horizontal line into which signals are written at the time of driving the plurality of signal lines by driving one of the plurality of scanning lines included in the display unit, and a signal line driving unit for causing the display unit to display an image by driving the plurality of signal lines on the basis of an input image signal includes a scanning control unit configured to control the scanning line driving unit so that a plurality of adjacent scanning lines are simultaneously driven in a horizontal line period in which an image signal of one horizontal line is output for display and the same pixel value is written into a plurality of adjacent pixels, and to control the scanning line driving unit so that combinations of a plurality of simultaneously driven scanning lines are changed in each period corresponding to a frame period of the input image signal.

A display control method according to an embodiment of the present invention of controlling a display panel unit including a display unit having a plurality of scanning lines and a plurality of signal lines, a scanning line driving unit for selecting a horizontal line into which signals are written at the time of driving the plurality of signal lines by driving one of the plurality of scanning lines included in the display unit, and a signal line driving unit for causing the display unit to display an image by driving the plurality of signal lines on the basis of an input image signal includes the steps of: controlling the scanning line driving unit so that a plurality of adjacent scanning lines are simultaneously driven in a horizontal line period in which an image signal of one horizontal line is output for display and the same pixel value is written into a plurality of adjacent pixels; and controlling the scanning line driving unit so that combinations of a plurality of simultaneously driven scanning lines are changed in each period corresponding to a frame period.

As described previously, in the present invention, a plurality of scanning lines are simultaneously driven and scanned in a period of one horizontal line, and combinations of a plurality of simultaneously driven scanning lines are changed in each period corresponding to a frame period. For example, a state in which a combination of scanning lines 0 and 1, a combination of scanning lines 2 and 3, and a combination of scanning lines 4 and 5 are set as combinations of simultaneously driven scanning lines is changed to a state in which the line 0 is set as an independently driven line and a combination of the scanning lines 1 and 2, a combination of the scanning lines 3 and 4, etc. are set as combinations of simultaneously driven scanning lines. By changing the combinations of a plurality of simultaneously driven scanning lines, it is possible to make light and dark patterns generated in these states different from each other. That is, the light state of a line at the time of displaying a certain frame is changed to the dark state of the line at the time of displaying another frame. The light and dark states of the line cancel each other. As a result, a light and dark pattern is not perceived. Furthermore, by changing the combinations of a plurality of simultaneously driven scanning lines in each period corresponding to a frame period, it is possible to displace the pixel centroid in a period corresponding to a frame period (in which a retina accumulates images), that is, to achieve, for example, the interlacing display method. Consequently, it is possible to improve a resolution sensitivity in the vertical direction that is reduced when a plurality of scanning lines are simply driven at the same time.

As described previously, according to an embodiment of the present invention, it is possible to prevent the occurrence of a light and dark pattern (stripes), which is a problem in the related art, when increasing a frame rate by driving a plurality of scanning lines at the same time in a period of one horizontal line. Furthermore, it is possible to improve a vertical resolution sensitivity as compared with a case in which a plurality of scanning lines are simply driven at the same time in a period of one horizontal line. As a result, according to an embodiment of the present invention, it is possible to improve moving image quality by increasing a frame rate and improve image quality by preventing the occurrence of stripes formed by light and dark states of lines and improving a vertical resolution sensitivity.

### BRIEF DESCRIPTION OF THE DRAWINGS

FIG. 1 is a diagram illustrating a configuration of a display panel included in a display apparatus according to an embodiment of the present invention;

FIGS. 2A and 2B are diagrams describing a scanning line driving method according to a first embodiment of the present invention (in which a plurality of lines are simultaneously driven and combinations of simultaneously driven lines are changed);

FIGS. 3A and 3B are diagrams describing a driving method according to the first embodiment in which the extraction and display of even-numbered lines or odd-numbered lines are also performed;

FIGS. 4A and 4B are diagrams describing the comparison between a frame rate obtained when a normal driving method is performed and a frame rate obtained when a driving method according to the first embodiment is performed;

FIG. 5 is a diagram illustrating an internal configuration of a display apparatus according to the first embodiment;

FIG. 6 is a diagram illustrating an internal configuration of a video signal processing section included in a display apparatus according to the first embodiment;

FIGS. 7A and 7B are diagrams illustrating driving waveforms of scanning lines when a driving method according to the first embodiment is performed;

FIGS. 8A and 8B are diagrams describing a driving method according to a second embodiment of the present invention;

FIG. 9 is a diagram describing a driving method according to the second embodiment;

FIGS. 10A and 10B are diagrams illustrating a pattern of light and dark states of lines when area divisional driving and simultaneous driving of two lines are performed in combination;

FIG. 11 is a diagram illustrating an internal configuration of a display apparatus according to the second embodiment;

FIG. 12 is a diagram illustrating an internal configuration of a video signal processing section included in a display apparatus according to the second embodiment;

FIGS. 13A and 13B are diagrams illustrating driving waveforms of scanning lines when a driving method according to the second embodiment is performed (in which combinations of two simultaneously driven lines with which no redundant line is generated are driven);

FIGS. 14A and 14B are diagrams illustrating driving waveforms of scanning lines when a driving method according to the second embodiment is performed (in which combinations of two simultaneously driven lines with which a redundant line is generated are driven);

FIG. 15 is a diagram describing a driving method according to a third embodiment of the present invention of simply associating one input pixel with two display pixels;

FIG. 16 is a diagram describing a driving method according to the third embodiment of associating an average of signal values of two adjacent input pixels with two display pixels;

FIGS. 17A to 17D are diagrams describing an effect obtained from a driving method according to the third embodiment;

FIG. 18 is a diagram illustrating an internal configuration of a video signal processing section included in a display apparatus according to the third embodiment;

FIG. 19 is a diagram describing normal bipolar driving;

FIGS. 20A to 20D are diagrams describing a problem that occurs when a bipolar driving method and switching between an EVEN frame and an ODD frame are performed;

FIG. 21 is a diagram illustrating the relationship between each frame and a driving polarity when a bipolar driving method and the switching between an EVEN frame and an ODD frame in each frame period are performed;

FIG. 22 is a diagram describing a driving method according to a fourth embodiment of the present invention;

FIG. 23 is a diagram illustrating an internal configuration of a video signal processing section included in a display apparatus according to the fourth embodiment;

FIG. 24 is a diagram illustrating the relationship among each frame, the waveform of an E/O switching signal, and the waveform of a polarity instruction signal when a driving method according to the fourth embodiment is performed;

FIG. 25 is a diagram describing a driving method according to a fifth embodiment of the present invention;

FIG. 26 is a diagram describing an internal configuration of a display apparatus according to the fifth embodiment;

FIG. 27 is a diagram illustrating the relationship among each frame, the waveform of an E/O switching signal, and the waveform of a polarity instruction signal when a driving method according to the fifth embodiment is performed;

FIG. 28 is a diagram illustrating an internal configuration of a display apparatus according to a sixth embodiment of the present invention;

FIG. 29 is a diagram illustrating an internal configuration of a video signal processing section included in a display apparatus according to the sixth embodiment;

FIG. 30 is a diagram illustrating an internal configuration of an image evaluation circuit included in a display apparatus according to the sixth embodiment;

FIG. 31 is a diagram describing a configuration of a modification of a display apparatus according to an embodiment of the present invention which divisionally driving signal lines in units of combinations of a predetermined number of signal lines;

FIG. 32 is a diagram describing a driving method in the related art of simultaneously driving a plurality of scanning lines;

FIG. 33 is a diagram illustrating a pattern of light and dark states of lines; and

FIG. 34 is a diagram describing an exemplary principle of the occurrence of a crosstalk between lines at the time of simultaneous driving of two lines.

### DESCRIPTION OF THE PREFERRED EMBODIMENTS

Embodiments of the present invention will be described below in the following order:
<1. First Embodiment>
[1-1. Configuration of Display Panel]
[1-2. Driving Method according to First Embodiment]
[1-3. Configuration of Display Apparatus]
<2. Second Embodiment>
[2-1. Driving Method according to Second Embodiment]
[2-2. Configuration of Display Apparatus]
<3. Third Embodiment>
[3-1. Driving Method according to Third Embodiment]
[3-2. Configuration of Display Apparatus]
<4. Fourth Embodiment>
[4-1. Bipolar Driving]
[4-2. Driving Method according to Fourth Embodiment]
[4-3. Configuration of Display Apparatus]
<5. Fifth Embodiment>
[5-1. Driving method according to Fifth Embodiment]
[5-2. Configuration of Display Apparatus]
<6. Sixth Embodiment>
[6-1. Driving Method according to Sixth Embodiment]
[6-2. Configuration of Display Apparatus]
<7. Modification>.

### 1. First Embodiment

### [1-1. Configuration of Display Panel]

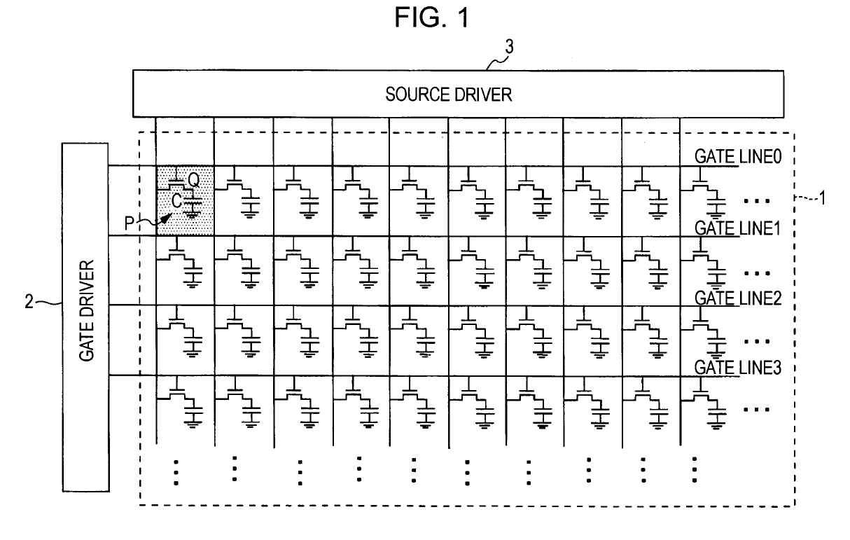

FIG. 1 is a diagram illustrating the configuration of a display panel included in a display apparatus according to an embodiment of the present invention. A display apparatus according to an embodiment of the present invention having an entire configuration to be described later is an active matrix liquid crystal display apparatus. FIG. 1 illustrates the configuration of a liquid crystal display panel included in a display apparatus according to an embodiment of the present invention that is such a liquid crystal display apparatus.

As illustrated in FIG. 1, a display panel includes a pixel array 1, a gate driver 2, and a source driver 3. The pixel array 1 includes an element substrate on which a plurality of scanning lines and a plurality of signal lines orthogonal to the scanning lines are formed and a combination of a capacitor C functioning as a voltage storage capacitor and a switching element Q is formed at each of intersections of the scanning lines and the signal lines. Although not illustrated, in the pixel array 1, a counter substrate is disposed at a position opposite to the element substrate and the space between the element substrate and the counter substrate is filled with liquid crystal. A combination of the capacitor C and the switching element Q that is disposed at each of the intersections of the scanning lines and the signal lines is a single pixel P in the pixel array 1.

In this case, a field-effect transistor (FET) is used as the switching element Q. The gate of the switching element Q is connected to a scanning line, the source of the switching element Q is connected to a signal line, and the drain of the switching element Q is connected to the capacitor C.

In the display panel illustrated in FIG. 1, the gate driver 2 is disposed to drive the scanning lines formed in the pixel array 1, and the source driver 3 is disposed to drive the signal lines.

When the gate driver 2 applies a voltage to a certain scanning line α (brings the scanning line α into an ON state), the switching elements Q connected to the scanning line α are turned on. This causes a state in which an electric charge can be stored in the capacitor C included in each of the pixels P arranged in the scanning line α (active state). That is, when the source driver 3 drives each signal line on the basis of a value corresponding to an input image signal after the gate driver 2 has brought the scanning line α into the active state, it is possible to write a desired signal value into each of the pixels P arranged in the scanning line α.

Here, each scanning line is also referred to as a gate line as illustrated in FIG. 1. Alternatively, each scanning line is also referred to as a horizontal line. Scanning lines in the pixel array 1 are numbered starting from zero for the uppermost scanning line. Although not illustrated, signal lines are also referred to as source lines or vertical lines, and are numbered from zero for the leftmost signal line. In this embodiment, the number of pixels P formed in the pixel array 1 is 1920 pixels in the horizontal direction×1080 pixels in the vertical direction. That is, there are vertical lines 0 to 1919 and horizontal lines 0 to 1079.

### [1-2. Driving Method According to First Embodiment]

### —Simultaneous Driving of a Plurality of Lines•Change in Combination of Simultaneously Driven Lines—

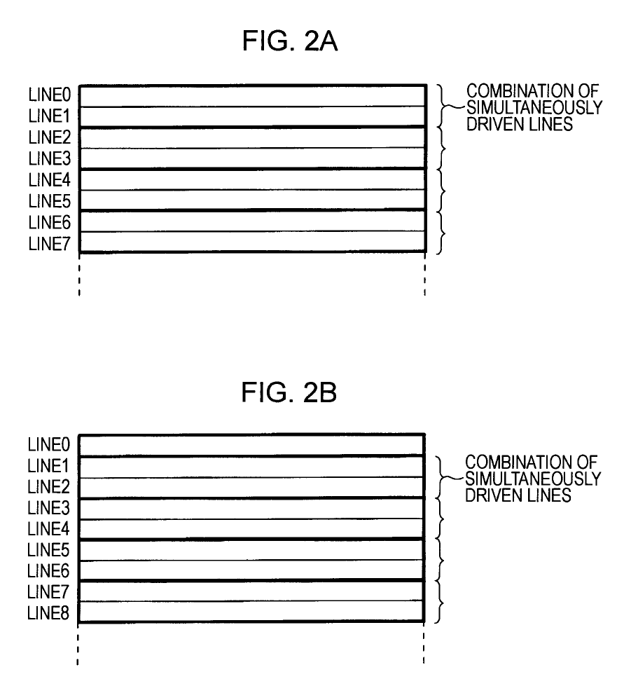

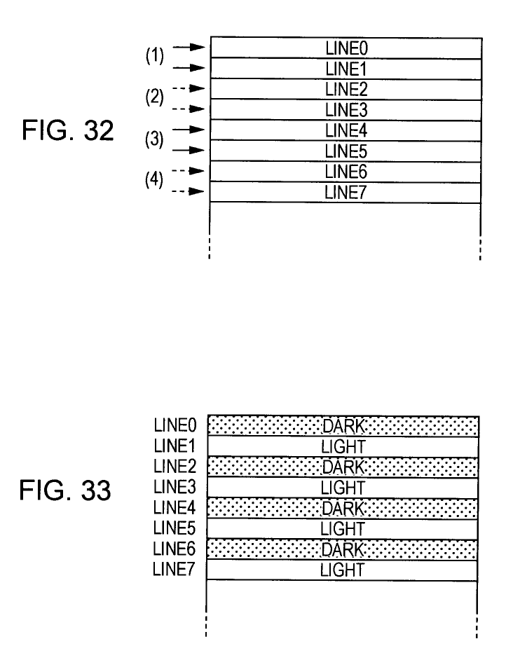

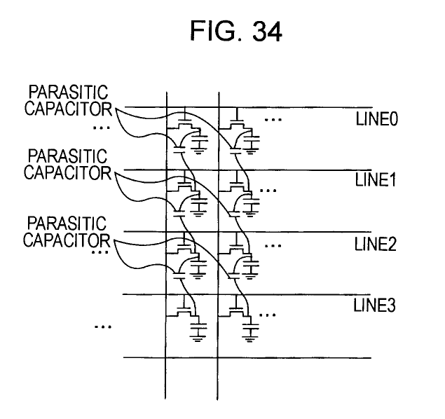

FIGS. 2A and 2B are diagrams describing a driving method according to the first embodiment. FIG. 2A illustrates the gate lines (horizontal lines) 0 to 7 extracted from the gate lines formed in the pixel array 1 illustrated in FIG. 1. FIG. 2B illustrates the gate lines 0 to 8 extracted from the gate lines formed in the pixel array 1 illustrated in FIG. 1. In this embodiment, in order to increase a frame rate, a method of driving a plurality of lines at the same time in a period of one horizontal line, which is similar to the method in the related art described previously with reference to FIG. 32, is performed. In this embodiment, the combinations of a plurality of simultaneously driven lines are changed as illustrated in FIGS. 2A and 2B. More specifically, in this case, the number of lines that are simultaneously driven in a period of one horizontal line is two, and the combinations of simultaneously driven lines are changed in each frame period (every frame). In this specification, a frame period means a frame period of an input image signal, that is, a frame period based on a synchronization signal obtained from an input video signal.

As illustrated in FIG. 2A, in a first frame period, a combination of lines 0 and 1, a combination of lines 2 and 3, a combination of lines 4 and 5, and a combination of lines 6 and 7 are sequentially driven as combinations of simultaneously driven lines. In a second frame period, as illustrated in FIG. 2B, the combinations of simultaneously driven lines are changed to a combination of the lines 1 and 2, a combination of the lines 3 and 4, a combination of the lines 5 and 6, and a combination of the line 7 and a line 8, and are sequentially driven.

When the method of driving a plurality of lines at the same time is employed, a redundant line incapable of being driven simultaneously with another line (that is, a line incapable of being included in the combination of a predetermined number of simultaneously driven lines) may be generated in accordance with the set number of horizontal lines included in the pixel array 1 and the number of simultaneously driven lines. In this example, since the number of horizontal lines included in the pixel array 1 is an even number and the number of simultaneously driven lines is two, lines incapable of being driven simultaneously with another line (the line 0 illustrated in FIGS. 2A and 2B and a line 1079 that is not illustrated in FIGS. 2A and 2B) are generated when driving is performed as illustrated in FIG. 2B. Each of these redundant lines is independently driven. Alternatively, when the number of simultaneously driven lines is set to three or more and the number of redundant lines is two or more, these redundant lines may be simultaneously driven. As is apparent from the above description, when the number of horizontal lines is an odd number, a redundant line may be generated with any combinations of simultaneously driven lines. That is, all combinations of simultaneously driven lines generate a redundant line. In this state, the combinations of simultaneously driven lines with which a redundant line is generated are changed.

Thus, by simultaneously driving a plurality of lines in a period of one horizontal line and sequentially changing combinations of simultaneously driven lines in each frame period, it is possible to prevent the generation of the pattern of light and dark states of lines illustrated in FIG. 33. This is apparent from the fact that a light and dark pattern generated when the driving method illustrated in FIG. 2A is performed differs from that generated when the driving method illustrated in FIG. 2B is performed. That is, when the driving method illustrated in FIG. 2A is performed, the dark-light-dark pattern illustrated in FIG. 33 is obtained from the line 0. On the other hand, when the driving method illustrated in FIG. 2B is performed, a light-dark-light pattern is obtained from the line 0. As a result, a light state and a dark state cancel each other in each line in two frame periods, and a viewer does not view stripes formed by the light and dark pattern.

### —Extraction and Display of Even-Numbered Line/Odd-Numbered Line—

When the method of driving a plurality of lines at the same time is employed, it is difficult to prevent the decrease in a vertical resolution. For example, when two lines are driven at the same time, a vertical resolution is reduced by half.

In this embodiment, in order to compensate for the decrease in a vertical resolution when two lines are driven at the same time, an image to be displayed is processed in addition to the above-described change in the combination of simultaneously driven lines.

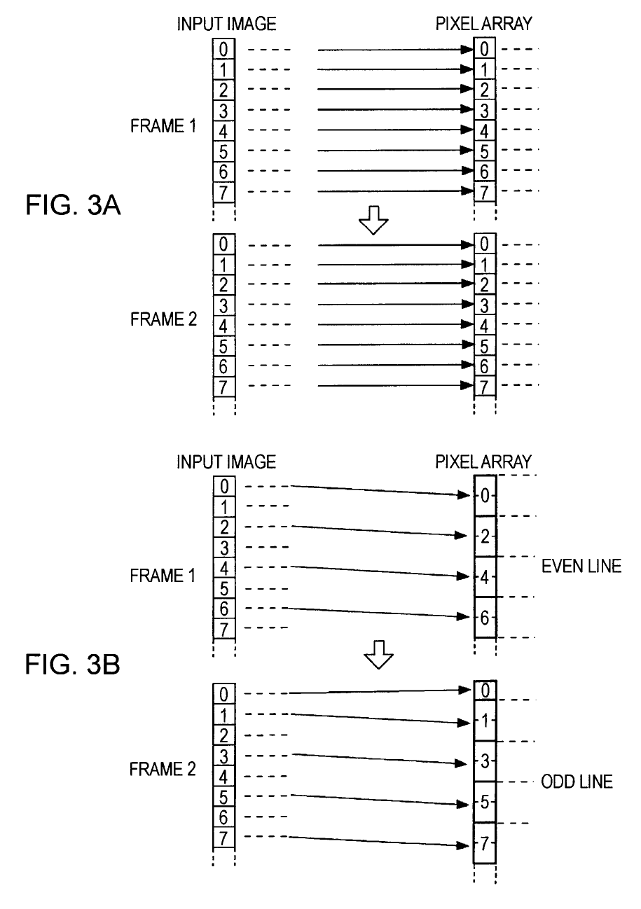

FIGS. 3A and 3B are diagrams describing a concrete method of processing an image to be displayed. FIG. 3A illustrates an image display method performed at the time of normal driving in which a plurality of lines are not simultaneously driven. FIG. 3B illustrates a driving method according to the first embodiment.

First, at the time of normal driving illustrated in FIG. 3A, a signal value of each horizontal line included in an input image (frame image) is written into a corresponding horizontal line included in the pixel array 1. Accordingly, pieces of data of all horizontal lines included in the input frame image are output for display in each frame period.

On the other hand, when the method of driving two lines at the same time is employed, assuming that an input image and the pixel array 1 have the same number of horizontal lines, it is difficult to display pieces of data of all horizontal lines included in the input image unlike in the case of normal driving. Accordingly, it is necessary to reduce the number of horizontal lines included in an image to be displayed by half.

As illustrated in FIG. 3B, in this embodiment, only even-numbered (EVEN) lines are extracted from a first frame image (frame 1) and are then output. A signal value of each of the extracted EVEN lines is input into a corresponding combination of two simultaneously driven lines in an image to be displayed. More specifically, an image signal of an extracted line 0 in the frame 1 is input into a combination of lines 0 and 1 in an image to be displayed, and an image signal of an extracted line 2 in the frame 1 is input into a combination of lines 2 and 3 in the image to be displayed. Thus, driving of simultaneously driven lines and writing of a signal value into these lines are performed in synchronization with each other so that the vertical order of lines in an input image is consistent with the vertical order of lines in an image to be displayed. In a second frame image (frame 2), only odd-numbered (ODD) lines are basically extracted and are then output. A signal value of each of the extracted ODD lines is input into a corresponding combination of two simultaneously driven lines. In this case, driving of each line (scanning line) and writing of a signal value into the line are similarly performed in synchronization with each other so that the vertical order of lines in an input image is consistent with the vertical order of lines in an image to be displayed. In the subsequent frame images, the extraction and output of EVEN lines and the extraction and output of ODD lines are alternately performed.

Referring to FIG. 3B, in a frame period in which ODD lines are extracted and output for display and combinations of simultaneously driven lines with which a redundant line is generated are used, the line 0 illustrated in the drawing and a line 1079 become redundant lines. At that time, when signal values of the ODD lines are individually input into the combinations of simultaneously driven lines as described previously, a signal value of the last line 1079 can be input into only the redundant scanning line 1079. Accordingly, a signal value of an ODD line having the largest line number in an input frame image is written into the last remaining redundant line (a scanning line having the largest line number) at the time of driving the last remaining redundant line as described previously.

In this case, there is no signal value to be input into the redundant line 0. That is, in this state, the line 0 is not displayed. Accordingly, when combinations of two simultaneously driven lines with which a redundant line is generated is used as described previously, ODD lines are extracted from an input image and are then output and a signal value of the line 0 in the input image is also output. Subsequently, the output signal value of the line 0 is written into the line 0 as illustrated in FIG. 3B.

As described previously, in the first embodiment, combinations of simultaneously driven lines are changed in each frame period and writing (display) of only EVEN lines included in an input frame image and writing (display) of only ODD lines included in the input frame image are alternately performed in each frame period. As a result, it is possible to displace the pixel centroid in a period in which a retina accumulates images, that is, to achieve, for example, the interlacing display method. Consequently, it is possible to compensate for the decrease in a vertical resolution sensitivity, which occurs when two lines are simply driven at the same time, by half. That is, it is possible to improve a vertical resolution sensitivity as compared with a case in which the method of simply driving a plurality of lines at the same time is employed. This leads to the improvement in image quality.

Furthermore, in this embodiment, when ODD lines are displayed, the signal value of the line 0 is also output and is then written into the redundant line 0. Another redundant line 1079 is independently scanned on the basis of a signal value of the line 1079. As a result, it is possible to prevent nondisplay states of the redundant lines and ensure the consistency between vertical orders of lines in an input image and an image to be displayed.

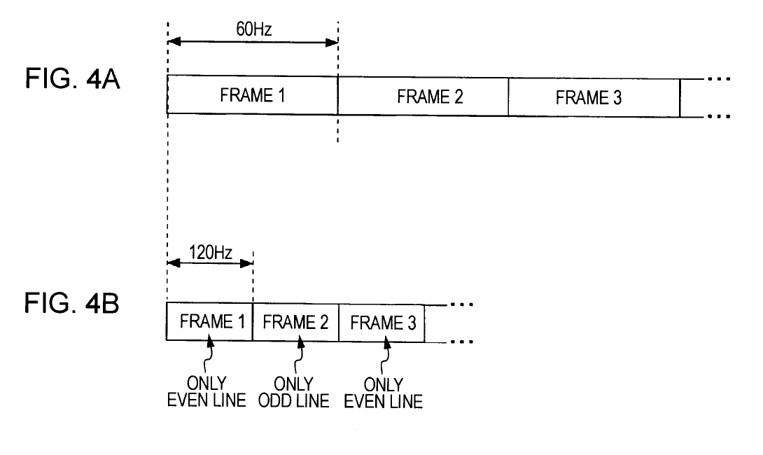

FIG. 4A illustrates a frame rate obtained when the normal driving method illustrated in FIG. 3A is performed. FIG. 4B illustrates a frame rate obtained when the above-described driving method according to the first embodiment is performed. As illustrated in FIG. 4A, it is assumed that a frame rate obtained when the normal driving method is performed is 60 Hz (60 fps). When a driving method according to the first embodiment is employed, it is possible to reduce a time length necessary for scanning of one frame image to half that at the time of the normal driving by driving two lines at the same time and alternately performing the extraction and output of EVEN lines and the extraction and output of ODD lines in each frame period as illustrated in FIG. 3B. As a result, it is possible to increase a frame rate from 60 Hz at the time of the normal driving to 120 Hz (120 fps).

### [1-3. Configuration of Display Apparatus]

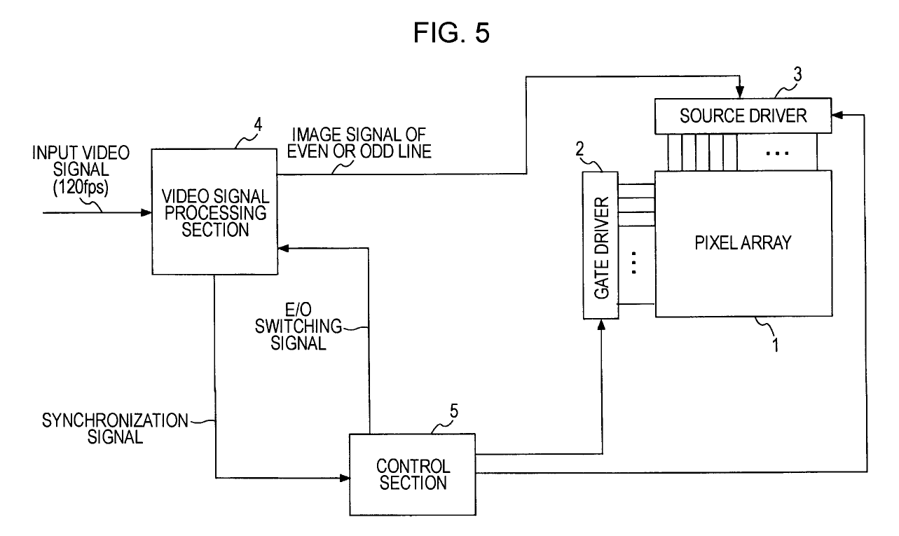

FIG. 5 is a diagram illustrating the internal configuration of a display apparatus according to the first embodiment. As illustrated in FIG. 5, a display apparatus according to the first embodiment includes the pixel array 1, the gate driver 2, and the source driver 3, which are illustrated in FIG. 1, a video signal processing section 4, and a control section 5.

First, the video signal processing section 4 receives an input video signal. As described previously with reference to FIGS. 4A and 4B, in this embodiment, a frame rate can be increased from 60 fps obtained with related art to 120 fps. Accordingly, an input video signal of 120 fps is supplied to the video signal processing section 4.

The video signal processing section 4 performs synchronization separation processing upon the input video signal and extraction processing of EVEN lines or ODD lines upon the input video signal on the basis of an EVEN/ODD switching signal (hereinafter referred to as an E/O switching signal) supplied from the control section 5.

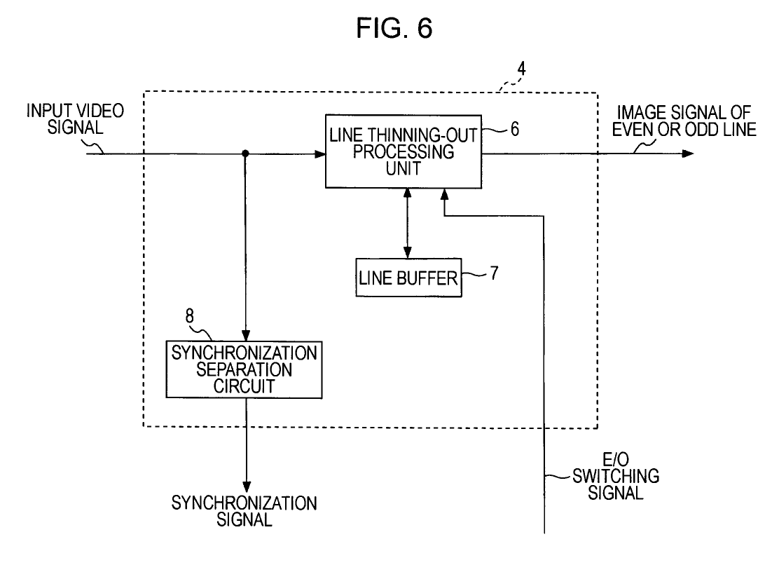

FIG. 6 is a diagram illustrating the internal configuration of the video signal processing section 4. The video signal processing section 4 includes a line thinning-out processing unit 6, a line buffer 7, and a synchronization separation circuit 8. The input video signal illustrated in FIG. 5 is supplied to the line thinning-out processing unit 6 and the synchronization separation circuit 8 as illustrated in FIG. 6. The synchronization separation circuit 8 separates a vertical synchronization signal and a horizontal synchronization signal from the input video signal. These synchronization signals separated by the synchronization separation circuit 8 are supplied to the control section 5 illustrated in FIG. 1.

The line thinning-out processing unit 6 extracts image signals of only even-numbered horizontal lines or extracts image signals of odd-numbered horizontal lines and an image signal of a line 0 from a frame image signal obtained from the input video signal on the basis of the E/O switching signal supplied from the control section 5 and outputs the extracted image signals. More specifically, when the line thinning-out processing unit 6 is instructed to output image signals of EVEN lines by the E/O switching signal, it extracts image signals of lines 0, 2, 4, . . . , and 1078 from the frame image signal obtained from the input video signal and sequentially outputs the extracted image signals using the line buffer 7. When the line thinning-out processing unit 6 is instructed to output image signals of ODD lines by the E/O switching signal, it extracts image signals of lines 1, 3, 5, . . . , and 1079 and an image signal of a line 0 from the frame image signal obtained from the input video signal and sequentially outputs the extracted image signals using the line buffer 7.

Referring back to FIG. 5, the control section 5 functions as a scanning control unit or an even/odd-numbered line output switching control unit on the basis of the synchronization signals supplied from the video signal processing section 4 (the synchronization separation circuit 8). The function of the scanning control unit is a function of controlling the gate driver 2 so that two lines are simultaneously driven and combinations of simultaneously driven lines are changed every frame as described previously with reference to FIG. 2. The function of the even/odd-numbered line output switching control unit is a function of supplying to the line thinning-out processing unit 6 an E/O switching signal used for an instruction for alternately performing the extraction and output of EVEN lines and the extraction and output of ODD lines (and the line 0) as described previously with reference to FIG. 3B.

The control section 5 supplies a timing signal used for an instruction for driving the scanning lines and the signal lines included in the pixel array 1 at a predetermined time based on the synchronization signal supplied from the video signal processing section 4. At that time, the control section 5 alternately transmits to the gate driver 2 in each frame period information used to instruct the gate driver 2 to sequentially drive a combination of lines 0 and 1, a combination of lines 2 and 3, a combination of lines 4 and 5, a combination of lines 6 and 7, etc. and information used to instruct the gate driver 2 to independently drive the line 0 and a line 1079 and sequentially drive a combination of the lines 1 and 2, a combination of the lines 3 and 4, a combination of the lines 5 and 6, etc. That is, the control section 5 alternately transmits to the gate driver 2 in each frame period based on the synchronization signal information used to instruct the gate driver 2 to sequentially drive combinations of two simultaneously driven lines with which no redundant line is generated and information used to instruct the gate driver 2 to sequentially drive combinations of two simultaneously driven lines with which a redundant line is generated and independently drive the redundant lines. As a result, in the pixel array 1, each scanning line is driven so that combinations of two simultaneously driven lines that are adjacent to each other in the vertical direction are sequentially driven and the combinations of two simultaneously driven lines are changed in each frame period.

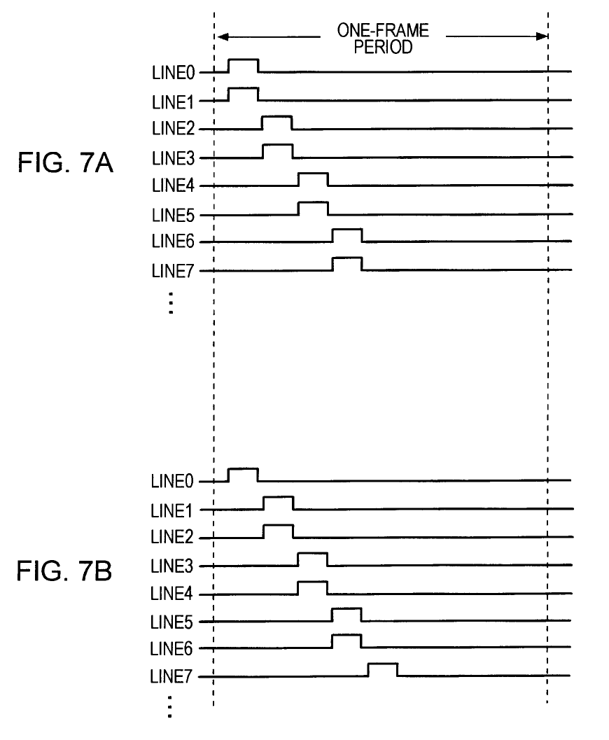

FIGS. 7A and 7B illustrate the waveforms of waves for driving scanning lines (horizontal lines) that are output by the gate driver 2 on the basis of the above-described information transmitted from the control section 5 in each frame period. FIG. 7A illustrates waveforms of driving waves that are used to sequentially drive the combination of the simultaneously driven lines 0 and 1, the combination of the simultaneously driven lines 2 and 3, the combination of the simultaneously driven lines 4 and 5, the combination of the simultaneously driven lines 6 and 7, etc. FIG. 7B illustrates waveforms of driving waves that are used to independently drive the line 0 and then sequentially drive the combination of the simultaneously driven lines 1 and 2, the combination of the simultaneously driven lines 3 and 4, the combination of the simultaneously driven lines 5 and 6, etc.

Furthermore, the control section 5 generates and outputs an E/O switching signal used to switch between EVEN lines and ODD lines in each frame period.

In this example, as illustrated in FIG. 3B, image signals of EVEN lines are output for display when combinations of a plurality of simultaneously driven lines with which no redundant line is generated are sequentially driven, and an image signal of the line 0 and image signals of ODD lines are output for display when combinations of a plurality of simultaneously driven lines with which a redundant line is generated are sequentially driven. However, on the contrary, image signals of ODD lines may be output for display when combinations of a plurality of simultaneously driven lines with which no redundant line is generated are sequentially driven, and image signals of EVEN lines may be output for display when combinations of a plurality of simultaneously driven lines with which a redundant line is generated are sequentially driven. In this case, a redundant line is generated at the time of display of EVEN lines. At that time, the signal value of an EVEN line (the line 0) having the smallest line number is written into a scanning line having a line number 0 at the time of driving the scanning line. As a result, for example, at the time of displaying ODD lines, the image of a line 1 in an input image is displayed at a combination of the scanning lines 0 and 1 and the image of a line 3 in the input image is displayed at a combination of scanning lines 2 and 3. On the other hand, at the time of displaying EVEN lines, the image of the line 0 in the input image is displayed at the scanning line 0 and the image of the line 2 in the input image is displayed at a combination of the scanning lines 1 and 2. Thus, at the time of displaying ODD lines and EVEN lines, it is possible to ensure that a display vertical positional relationship among lines in an input image is consistent with a display vertical positional relationship among lines in an image to be displayed.

### Second Embodiment

### [2-1. Driving Method According to Second Embodiment]

In the second embodiment, the reduction in a time length necessary for scanning of one frame is achieved by dividing the pixel array 1 into a plurality of areas and independently (simultaneously) performing driving of scanning lines in these areas. Furthermore, a frame rate is increased to at least four times a frame rate at the time of normal driving by performing the scanning described in the first embodiment in each of these areas.

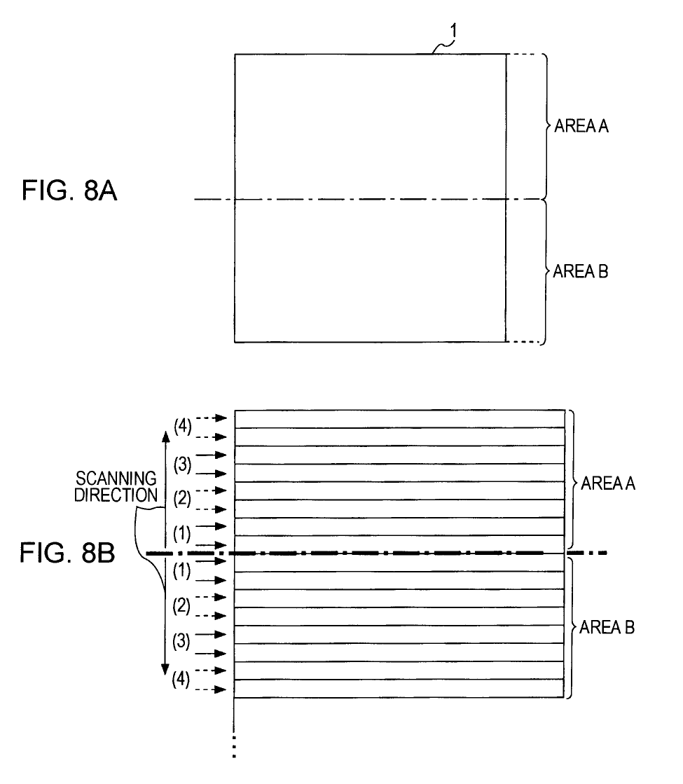

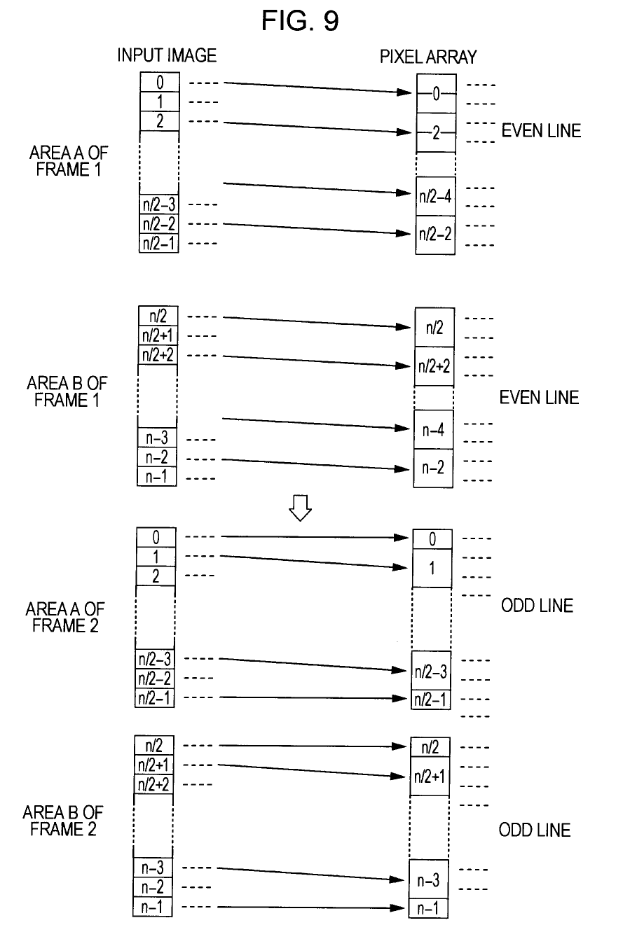

FIGS. 8A, 8B, and 9 are diagrams describing a driving method according to the second embodiment. First, as illustrated in FIG. 8A, in the second embodiment, the pixel array 1 is equally divided into two areas, an upper area A and a lower area B, in a vertical direction.

At that time, for example, as illustrated in FIG. 8B, by performing sequential driving of combinations of two adjacent simultaneously driven horizontal lines in the areas A and B at the same time, it is possible to reduce a time length necessary for scanning of one frame to one fourth of that necessary at the time of normal driving. That is, it is possible to increase a frame rate by four times.

In this case, as illustrated in FIG. 8B, scanning directions in the areas differ from each other. Thus, by making scanning directions (scanning sequences) in the areas different from each other, it is possible to prevent the misalignment between images at the boundary between areas at the time of display of a moving image, which is a problem caused when a frame rate is increased by dividing a pixel array into areas. This leads to improvement in moving image quality (see Japanese Unexamined Patent Application Publication No. 2007-212571).

As described previously, in the second embodiment, a driving method similar to that according to the first embodiment, that is, a driving method of changing the combinations of simultaneously driven lines in each frame period and alternately setting EVEN lines and ODD lines as lines to be displayed, is performed in each of the areas A and B. FIG. 9 illustrates a concrete driving method according to the second embodiment in which the combinations of simultaneously driven lines are changed in each frame period and EVEN lines and ODD lines are alternately set as lines to be displayed. FIG. 9 illustrates a display state transition in display periods of two frames, frames 1 and 2. First, in the frame 1, only image signals of EVEN lines in the areas A and B are extracted and output as illustrated in FIG. 9. Referring to FIG. 9, the number of horizontal lines in the pixel array 1 (=horizontal lines in a frame image) is set to n. Accordingly, horizontal lines 0 to n/2−1 are included in the area A and lines n/2 to n−1 are included in the area B.

In the frame 1, a combination of lines 0 and 1, a combination of lines 2 and 3, . . . , and a combination of lines n/2−2 and n/2−1 are set as combinations of simultaneously driven lines in the area A, and a combination of lines n/2 and n/2+1, a combination of lines n/2+2 and n/2+3, . . . , a combination of lines n−4 and n−3, and a combination of lines n−2 and n−1 are sets as combinations of simultaneously driven lines in the area B. Both the combinations of simultaneously driven lines in the area A and the combinations of simultaneously driven lines in the area B generate no redundant line.

As is apparent from FIG. 9, like in the above-described case, in this case, each combination of simultaneously driven lines and a signal value (line included in an input image) written into the combination of simultaneously driven lines at the time of driving the combination of simultaneously driven lines are associated with each other so that the vertical order of lines in an input image is consistent with the vertical order of lines in an image to be displayed.

In this case, as illustrated in FIG. 8B, a scanning start position is on the side of the boundary between the areas A and B. Accordingly, lines are scanned in descending order of line number in the area A, and lines are scanned in ascending order of line number in the area B.

Subsequently, in the frame 2, image signals of a line 0 and ODD lines in the area A are extracted and output and image signals of a line n/2 and ODD lines in the area B are extracted and output. On the other hand, a combination of lines 1 and 2, . . . , and a combination of lines n/2−3 and n/2−2 are set as combinations of simultaneously driven lines in the area A, and a combination of lines n/2+1 and n/2+2, . . . , and a combination of lines n−3 and n−2 are set as combinations of simultaneously driven lines in the area B. That is, the combinations of simultaneously driven lines in the area A generate the line 0 and a line n/2−1 as redundant lines, and the combinations of simultaneously driven lines in the area B generate lines n/2 and n−1 as redundant lines. Like in the above-described case, in this case, a signal value of a line 0 is written into the line 0. In the area B, a signal value of a line n/2 is written into the line n/2. As a result, like in the above-described case, in this case, it is possible to prevent the non-display states of the redundant lines.

As described previously, in this example, a scanning start position in each of the areas is on the side of the boundary between the areas. In this case, a scanning sequence in the area B is the same as that in the first embodiment. Accordingly, a driving method according to the first embodiment can be performed in the area B. Although a scanning direction in the area A is opposite to that in the first embodiment, the relationship between each line and an image to be displayed in the line is the same as that in the first embodiment (that is, it is ensured that a display vertical positional relationship among lines in an input image is consistent with a display vertical positional relationship among lines in an image to be displayed).

As described previously, in the second embodiment, the pixel array 1 is divided into the areas A and B. Like in the first embodiment, in each of the areas A and B, two adjacent lines are simultaneously driven and combinations of simultaneously driven lines are changed in each frame period. As a result, like in the first embodiment, it is possible to prevent the generation of stripes formed by light and dark states of lines at the time of simultaneously driving a plurality of pixels. Since the combinations of simultaneously driven lines are changed in each frame period and EVEN lines and the ODD lines are alternately output as lines to be displayed as described previously, it is possible to achieve a scanning method, for example, the interlacing display method, like in the first embodiment. This leads to the improvement in vertical resolution sensitivity.

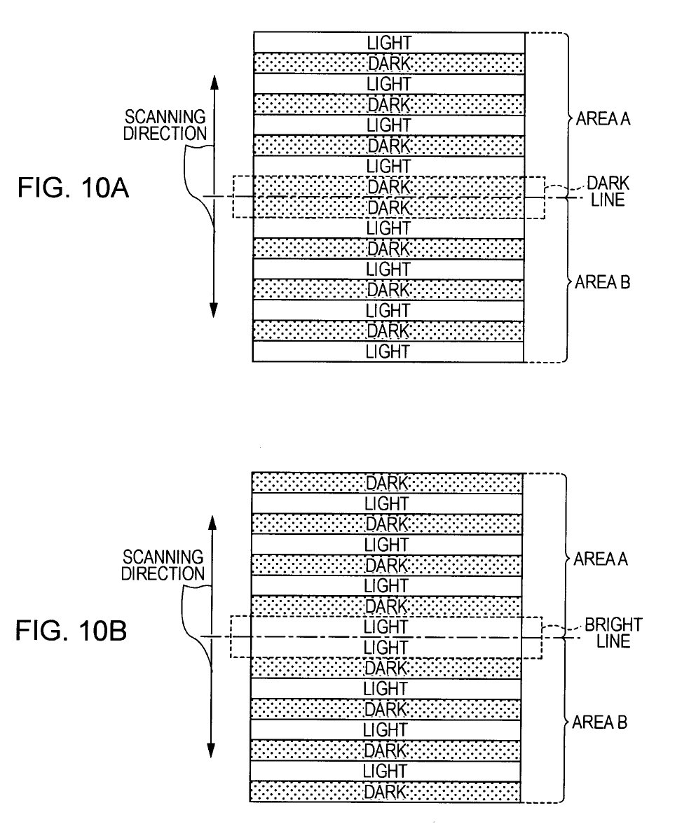

Dislike in this embodiment, if the change in the combinations of simultaneously driven lines is not performed when a pixel array is divided into areas so as to increase a frame rate, the succession of dark states of lines and the succession of light states of lines are generated at the boundary between the areas and allow a viewer to view a dark line and a bright line at the boundary between the areas as illustrated in FIGS. 10A and 10B. For example, like in this example, when the number of horizontal lines is an even number, the number of simultaneously driven lines is two, and combinations of simultaneously driven lines generate no redundant line, light and dark patterns generated in the areas A and B are as illustrated in FIG. 10A. Accordingly, in this case, two lines at the boundary between the areas A and B become dark and a dark line is therefore viewed at the boundary between the areas A and B. When the number of horizontal lines is an even number, the number of simultaneously driven lines is two, and combinations of simultaneously driven lines generate a redundant line, light and dark patterns generated in the areas A and B are as illustrated in FIG. 10B. Accordingly, in this case, two lines at the boundary between the areas A and B become light and a bright line is therefore viewed at the boundary between the areas A and B.

When combinations of simultaneously driven lines are changed in each of areas in each frame period with a driving method according to the second embodiment, it is possible to reverse the state (light/dark) of each line in the area in each frame period. As a result, the light state and dark state of each line can be canceled each other. That is, according to the second embodiment, when a pixel array is divided into areas and two lines are simultaneously driven in each of the areas, it is possible to prevent the generation of bright and dark lines at the boundary between the areas illustrated in FIGS. 10A and 10B.

### [2-2. Configuration of Display Apparatus]

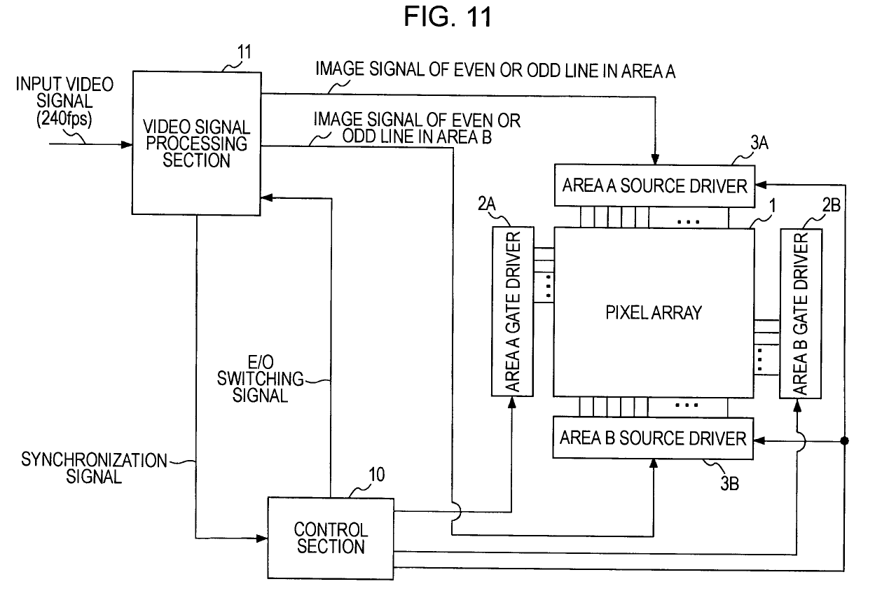

FIG. 11 is a diagram illustrating the internal configuration of a display apparatus according to the second embodiment for achieving the above-described driving method according to the second embodiment. In drawings including FIG. 11 describing the configuration of a display apparatus (including the internal configuration of a video signal processing section), the same reference numerals are used to identify components that have already been described so as to prevent repeated explanation.

This display apparatus includes an area A gate driver 2A for driving each scanning line (each of the lines 0 to n/2−1 in the example illustrated in FIG. 9) in the area A and an area B gate driver 2B for driving each scanning line (each of the lines n/2 to n−1 in the example illustrated in FIG. 9) in the area B. In addition, the display apparatus includes an area A source driver 3A and an area B source driver 3B so as to independently performing scanning in the areas A and B.

In the second embodiment, as described previously, it is possible to increase a frame rate to four times a frame rate (60 fps) at the time of normal driving. Accordingly, a video signal of 240 fps is input into this display apparatus as illustrated in FIG. 11. Furthermore, in the second embodiment, as described previously, since scanning is performed starting from the line n/2−1 in the area A, the area A gate driver 2A is configured to perform scanning starting from the line n/2−1.

The display apparatus illustrated in FIG. 11 includes a video signal processing section 11 instead of the video signal processing section 4 included in the display apparatus illustrated in FIG. 5.

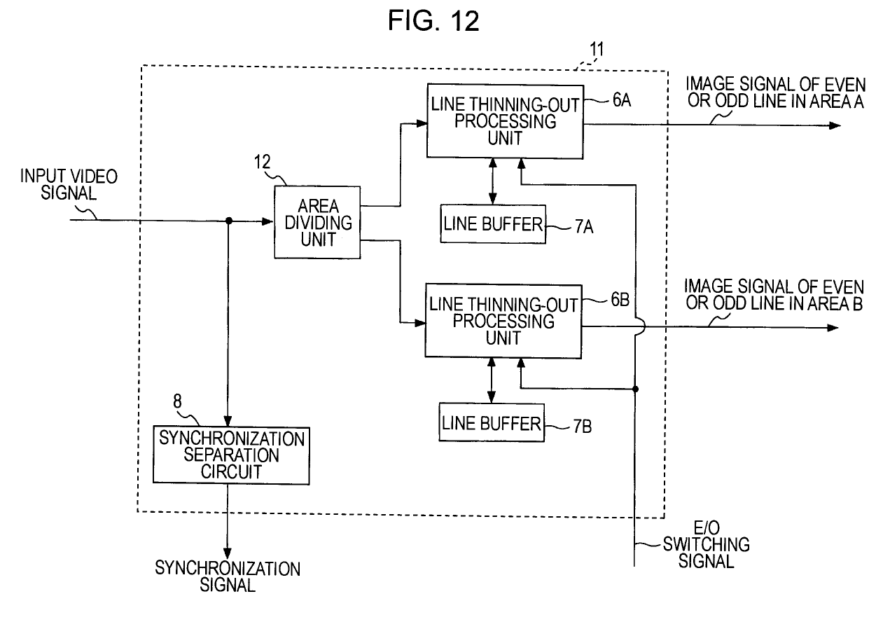

FIG. 12 is a diagram illustrating the internal configuration of the video signal processing section 11. As illustrated in FIG. 12, the video signal processing section 11 includes an area dividing unit 12, a combination of a line thinning-out processing unit 6A and a line buffer 7A, a combination of a line thinning-out processing unit 6B and a line buffer 7B, and the synchronization separation circuit 8.

The area dividing unit 12 divides a frame image signal obtained from the input video signal into image signals for areas set in the pixel array 1 and outputs the image signals. More specifically, in this case, the area dividing unit 12 divides the frame image signal into image signals of lines 0 to n/2−1 for the area A and image signals of lines n/2 to n−1 for the area B and outputs these image signals.

The image signals for the area A are supplied to the line thinning-out processing unit 6A, and the image signals for the area B are supplied to the line thinning-out processing unit 6B. The line thinning-out processing units 6A and 6B perform thinning-out processing upon the image signals and output results of the thinning-out processing using the line buffers 7A and 7B, respectively. In the area B, like in the first embodiment, lines are scanned in ascending order of line number. Accordingly, the line thinning-out processing unit 6B performs the same processing performed by the line thinning-out processing unit 6 illustrated in FIG. 6, that is, selects which of input image signals of EVEN lines and input image signals of ODD lines (in addition, an image signal of a line n/2 that is an EVEN line having the smallest line number in an input image) will be output on the basis of an E/O switching signal and outputs the selected image signals. On the other hand, in the area A, scanning is performed starting from a line n/2−1. Accordingly, the line thinning-out processing unit 6A is configured to extract lines and output the extracted lines in descending order of line number. When the line thinning-out processing unit 6A is instructed to extract ODD lines by the E/O switching signal, it outputs an image signal of the line 0 in addition to image signals of ODD lines.

Referring back to FIG. 11, a control section 10 supplies a timing instruction based on a synchronization signal to the area A gate driver 2A, the area B gate driver 2B, the area A source driver 3A, and the area B source driver 3B and provides an instruction for switching between EVEN lines and ODD lines to be extracted and output using an E/O switching signal. More specifically, the control section 10 supplies timing signals to the area A gate driver 2A, the area B gate driver 2B, the area A source driver 3A, and the area B source driver 3B so that scanning line driving and signal line driving are performed in the areas A and B at a predetermined time based on the synchronization signal supplied from the video signal processing section 11 (the synchronization separation circuit 8). At that time, the control section 10 alternately transmits to each of the area A gate driver 2A and the area B gate driver 2B in each frame period information used for an instruction for sequentially driving combinations of two simultaneously driven lines with which no redundant line is generated and information used for an instruction for sequentially driving combinations of two simultaneously driven lines with which a redundant line is generated. As a result, in each of the areas A and B in the pixel array 1, each scanning line is driven so that combinations of two simultaneously driven lines that are adjacent to each other in the vertical direction are sequentially driven and the combinations of two simultaneously driven lines are changed in each frame period.

Furthermore, the control section 10 generates and outputs an E/O switching signal used for an instruction for switching between EVEN lines and ODD lines in each frame period like in the first embodiment. However, dislike in the first embodiment, the generated E/O switching signal is supplied to the line thinning-out processing unit 6A and the line thinning-out processing unit 6B as illustrated in FIG. 12.

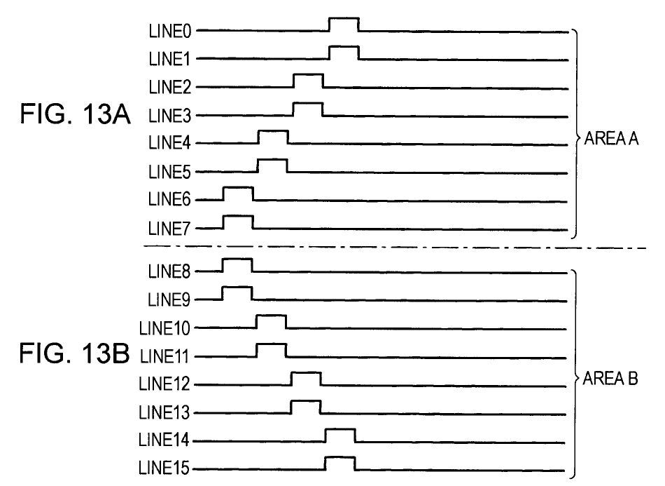

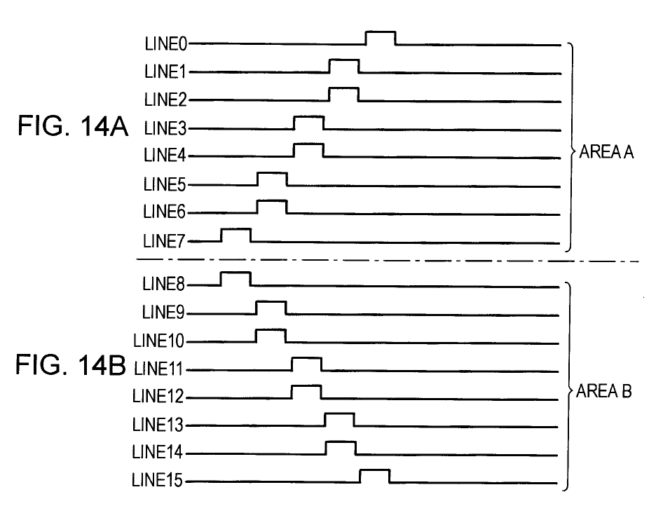

FIGS. 13A and 14A are diagrams illustrating the waveforms of waves for driving scanning lines (horizontal lines) that are output by the area A gate driver 2A under the above-described control of the control section 10. FIGS. 13B and 14B are diagrams illustrating the waveforms of waves for driving scanning lines (horizontal lines) that are output by the area B gate driver 2B under the above-described control of the control section 10. For convenience of illustration, FIGS. 13A and 14A illustrate eight lines (lines 0 to 7) included in the area A, and FIGS. 13B and 14B illustrate eight lines (lines 8 to 15) included in the area B.

FIGS. 13A and 13B illustrate the waveforms of waves for driving combinations of two lines with which no redundant line is generated. FIGS. 14A and 14B illustrate the waveforms of waves for driving combinations of two lines with which a redundant line is generated.

### 3. Third Embodiment

### [3-1. Driving Method According to Third Embodiment]

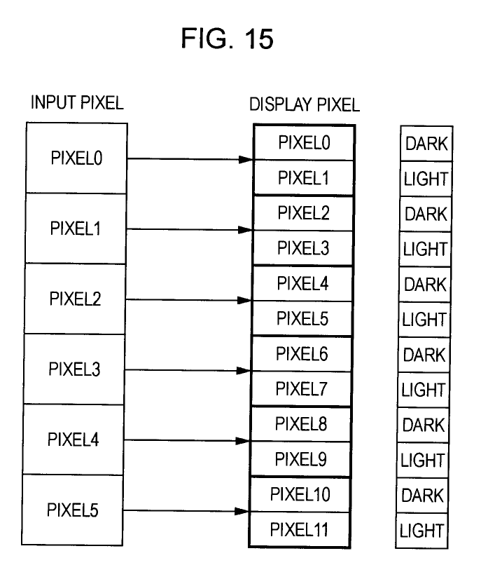

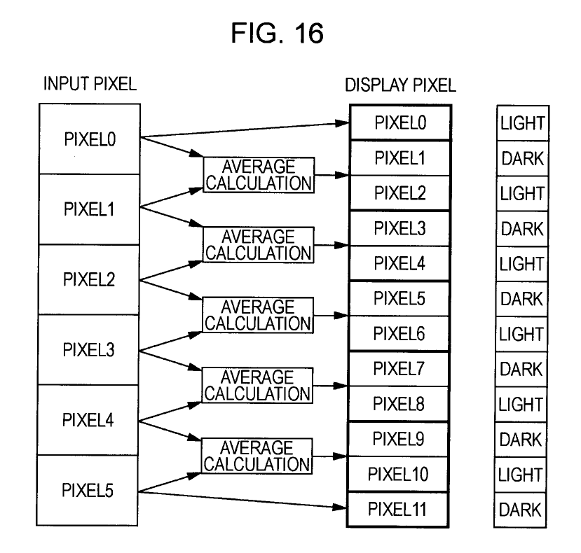

The third embodiment of the present invention will be described. In the third embodiment, as illustrated in FIG. 15, the generation of a light and dark pattern is prevented when the number of pixels in the vertical direction (horizontal lines=scanning lines) in the pixel array 1 is twice the number of pixels in the vertical direction in a frame image obtained from an input video signal. For convenience of illustration, FIG. 15 (and FIG. 16 to be described later) illustrates six input pixels (pixels 0 to 5) in the vertical direction and twelve display pixels (pixels 0 to 11) in the vertical direction.

Thus, when the number of display pixels in the vertical direction is twice the number of input pixels in the vertical direction, combinations of two adjacent display pixels (two adjacent lines) are sequentially driven so that input pixels (signal values) are individually associated with the combinations of two adjacent display pixels as illustrated in FIG. 15. As a result, it is possible to reduce a time length necessary for scanning of one frame image by half and increase a frame rate to double a frame rate at the time of normal driving (to 120 fps when a frame rate at the time of normal driving is 60 fps). However, in this case, like in the above-described case, the display states (light/dark) of lines may generate a light and dark pattern and stripes formed by the light and dark pattern may be viewed as illustrated in the rightmost column in FIG. 15.

In the third embodiment, like in the above-described embodiments, combinations of two adjacent lines are sequentially driven and are changed in each frame period. As a result, like in the above-described embodiments, it is possible to prevent the generation of stripes formed by a light and dark pattern.

In the third embodiment, the change in an image to be displayed is performed in each frame period in addition to the simultaneous driving of two lines and the change in the combinations of simultaneously driven lines in each frame period. More specifically, as illustrated in FIG. 15, when combinations of two simultaneously driven lines with which no redundant line is generated are driven, image display is performed so that input pixels are individually associated with combinations of two display pixels that are adjacent to each other in the vertical direction. On the other hand, as illustrated in FIG. 16, when the combinations of two simultaneously driven lines with which a redundant line is generated are driven, an input pixel having the smallest pixel number and an input pixel having the largest pixel number are associated with display pixels 0 and 11, respectively, that are redundant display pixels. Furthermore, the input pixels are grouped into combinations of two adjacent input pixels, and an average of two adjacent input pixels included in each of the combinations of two adjacent input pixels is calculated and is associated with a corresponding combination of two simultaneously driven display pixels.

For convenience of illustration, FIGS. 15 and 16 illustrate the relationship between one of input pixels included in each horizontal line and corresponding one of display pixels included in a corresponding horizontal line. However, in reality, the illustrated relationship is established between each of input pixels included in each horizontal line and corresponding one of display pixels included in a corresponding horizontal line. More specifically, when combinations of simultaneously driven lines with which no redundant line is generated are driven as illustrated in FIG. 15, each signal line is driven on the basis of an image signal of each horizontal line included in a frame image signal obtained from an input video signal. In the case of combinations of simultaneously driven lines with which a redundant line is generated illustrated in FIG. 16, when a line (scanning line) having the smallest line number is driven, each signal line is driven on the basis of an image signal of a horizontal line having the smallest line number included in a frame image signal obtained from an input video signal. When a line (scanning line) having the largest line number is driven, each signal line is driven on the basis of an image signal of a horizontal line having the largest line number included in the frame image signal obtained from the input video signal. When each of the combinations of simultaneously driven lines excluding the line having the smallest line number and the line having the largest line number is driven, an average of values of image signals of two horizontal lines corresponding to the combination of two simultaneously driven lines (scanning lines) is calculated on a pixel-by-pixel basis, a calculation result is set as an image signal of one horizontal line, and each signal line is driven on the basis of the image signal of one horizontal line. As is apparent from FIGS. 15 and 16, the relationship between each combination of simultaneously driven lines and a signal value written into the combination of simultaneously driven lines at the time of driving the combination of simultaneously driven lines is established so that the vertical order of lines in an input image is consistent with the vertical order of lines in an image to be displayed.

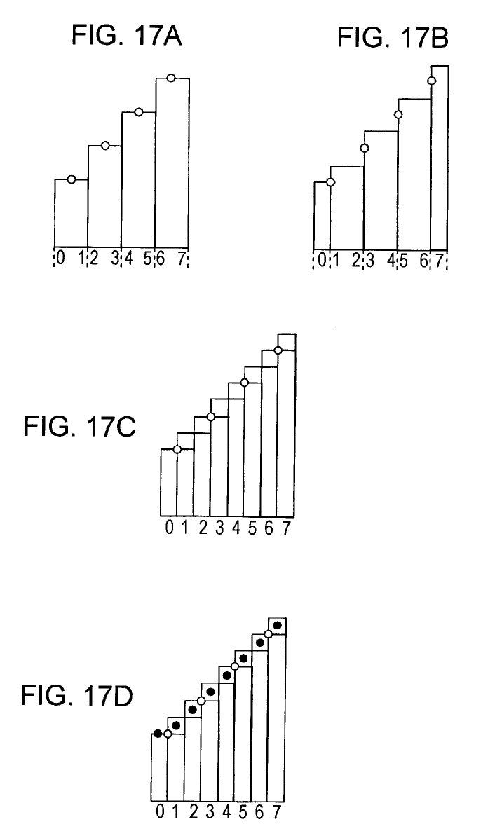

Effects obtained by performing the above-described driving method according to the third embodiment will be described with reference to FIGS. 17A to 17D. In FIGS. 17A to 17D, horizontal axes represent the number of display pixels in the vertical direction (eight pixels from a pixel 0 to a pixel 7 in this example), white circles represent an input brightness value, and vertical bars represent a display brightness value.

FIG. 17A illustrates the brightness level of each pixel in a case where the driving method illustrated in FIG. 15 is performed (combinations of simultaneously driven lines generate no redundant line and a display image=an input image). FIG. 17B illustrates the brightness level of each pixel in a case where the driving method illustrated in FIG. 16 is performed (combinations of simultaneously driven lines generate a redundant line and the average signal value of adjacent pixels is used to display an image in simultaneously driven lines included in each of the combinations of simultaneously driven lines).

FIG. 17C illustrates a state in which the display image illustrated in FIG. 17A and the display image illustrated in FIG. 17B are superimposed. For example, in the case of a high frame rate greater than 120 fps like in this example, a viewer perceives brightness levels illustrated in FIG. 17C.

FIG. 17D illustrates black circles on the superimposed image illustrated in FIG. 17C so as to prominently display brightness levels perceived by a viewer. It is apparent from FIG. 17D that the black circles are displaced by ¼ pixel and ¾ pixel from the positions of input pixels (that is, the position of pixels 0+1, the position of pixels 2+3, etc.). This is equivalent to that an input image is resampled at positions that are displaced by ¼ pixel and ¾ pixel from normal pixel positions in the vertical direction. Accordingly, it is possible to improve a resolution sensitivity in the vertical direction. This is apparent from the fact that the distances between the black circles are narrower than those between the white circles representing brightness levels perceived when two adjacent lines are simply driven at the same time (without changing combinations of simultaneously driven lines every frame). At that time, values indicated by the black circles illustrated in FIG. 17D are brightness values obtained from (3A+B)/4 and (A+3B)/4 where A and B individually represent the values of adjacent input pixels.

As described previously, in the third embodiment, assuming that the number of pixels in the vertical direction in the pixel array 1 is twice the number of pixels in the vertical direction in an input image, it is possible to prevent the generation of stripes formed by a light and dark pattern by simultaneously driving two lines and changing combinations of simultaneously driven lines like in the above-described embodiments. This leads to improvement in image quality. In addition, as described previously with reference to FIGS. 15 and 16, by alternately performing the simple output of an image signal of each horizontal line and the output of an average signal value of adjacent pixels in each frame period, it is possible to prevent a resolution sensitivity in the vertical direction from being reduced by half when two lines are simply driven at the same time. This leads to improvement in image quality.

### [3-2. Configuration of Display Apparatus]

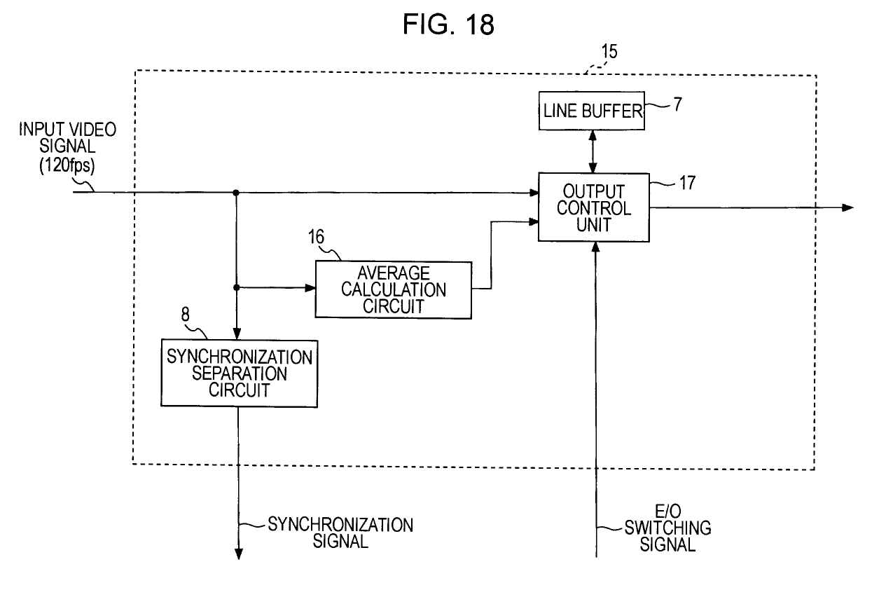

The configuration of a display apparatus according to the third embodiment for achieving the above-described driving method according to the third embodiment will be described with reference to FIG. 18. The internal configuration of a display apparatus according to the third embodiment is approximately the same as that of a display apparatus according to the first embodiment illustrated in FIG. 5 except that a video signal processing section 15 is used instead of the video signal processing section 4. Accordingly, FIG. 18 illustrates the internal configuration of the video signal processing section 15 included in a display apparatus according to the third embodiment. The illustration and description of the entire internal configuration of the display apparatus will be omitted.

As described previously, since a frame rate can be set to twice a frame rate (60 fps) at the time of normal driving, a video signal of 120 fps is input into the video signal processing section 15 as illustrated in FIG. 18.

The video signal processing section 15 includes the synchronization separation circuit 8, an average calculation circuit 16, an output control unit 17, and the line buffer 7. In the video signal processing section 15, the input video signal is supplied to the synchronization separation circuit 8, the average calculation circuit 16, and the output control unit 17.

In the video signal processing section 15, the average calculation circuit 16, the output control unit 17, and the line buffer 7 function as a normal output/average output switching processing unit for switching between normal output processing for sequentially outputting image signals of horizontal lines included in a frame image obtained from the input video signal and average output processing for grouping the horizontal lines included in the frame image into combinations of two adjacent horizontal lines, calculating an average of image signals of two adjacent horizontal lines included in each of the combinations of two adjacent horizontal lines on a pixel-by-pixel basis, and outputting a result of the calculation.

More specifically, the average calculation circuit 16 groups the horizontal lines included in the frame image obtained from the input video signal into combinations of two adjacent horizontal lines, calculates an average of image signals of two adjacent horizontal lines included in each of the combinations of two adjacent horizontal lines on a pixel-by-pixel basis, and outputs a result of the calculation to the output control unit 17.

The output control unit 17 performs output control of an image signal supplied to the source driver 3 (not illustrated) by switching, on the basis of an E/O switching signal transmitted from the control section 5 (not illustrated), between processing for receiving from the average calculation circuit 16 a pixel-by-pixel average of signal values of adjacent lines included in each combination of adjacent lines and line-sequentially outputting these averages using the line buffer 7 and processing for line-sequentially outputting image signals of horizontal lines included in a frame image signal obtained from an input video signal using the line buffer 7. More specifically, when the E/O switching signal indicates an EVEN instruction, the output control unit 17 performs the processing for line-sequentially outputting image signals of horizontal lines included in a frame image signal obtained from an input video signal. When the E/O switching signal indicates an ODD instruction, the output control unit 17 performs the processing for receiving from the average calculation circuit 16 a pixel-by-pixel average of signal values of adjacent lines included in each combination of adjacent lines and line-sequentially outputting these averages. As a result, in a frame period in which the E/O switching signal indicates the EVEN instruction (that is, in a period in which combinations of two simultaneously driven lines with which no redundant line is generated are sequentially driven), the image signals of horizontal lines included in the frame image signal are sequentially output to the source driver 3. That is, the driving method described previously with reference to FIG. 15 is achieved. In a frame period in which the E/O switching signal indicates the ODD instruction (that is, in a period in which combinations of two simultaneously driven lines with which a redundant line is generated are sequentially driven), averages of signal values of adjacent horizontal lines are sequentially output to the source driver 3. That is, the driving method described previously with reference to FIG. 16 is achieved.

### 4. Fourth Embodiment

### [4-1. Bipolar Driving]

The fourth embodiment of the present invention will be described. In the fourth embodiment, and fifth and sixth embodiments to be described later, a bipolar driving method is performed. A bipolar driving method is known as a driving method used to keep a DC balance of a writing voltage and is employed in, for example, Liquid Crystal On Silicon (LCOS) panels and Silicon X-tal Reflective Display (SXRD: the registered trademark of Sony Corporation) panels.

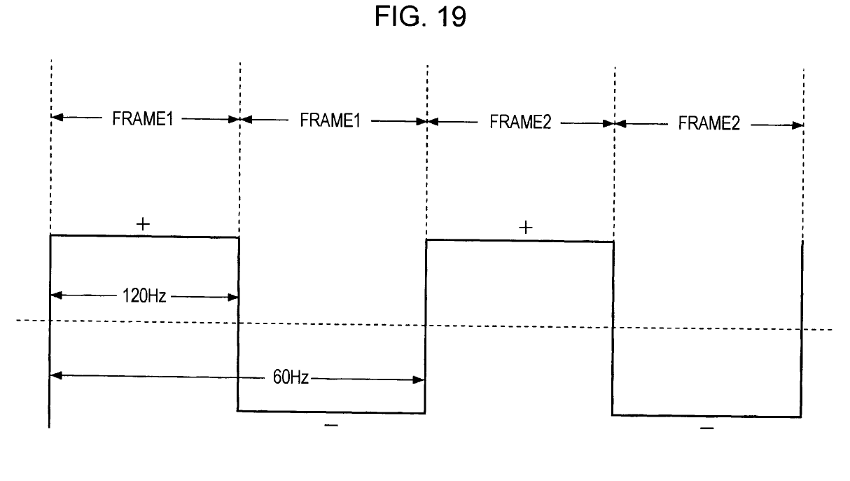

FIG. 19 is a conceptual diagram of normal bipolar driving (bipolar driving in the related art). For example, when the frame rate of an input video signal is 60 Hz, the polarity of a writing voltage is reversed at a rate of 120 Hz and the same frame is output two times at the time of bipolar driving as illustrated in FIG. 19 so as to keep the DC balance of a writing voltage. More specifically, focusing attention on a frame 1 in FIG. 19, signal values of the frame 1 are written in a positive polarity in a first half of a period of 60 Hz (approximately 16.6 msec) of one input frame, and signal values of the frame 1 are written in a negative polarity in a latter half of the period. Thus, writing of signal values of the same frame image is performed in both the positive polarity and the negative polarity. As a result, the positive polarity of signal values and the negative polarity of signal values cancel each other and a DC balance can be maintained.

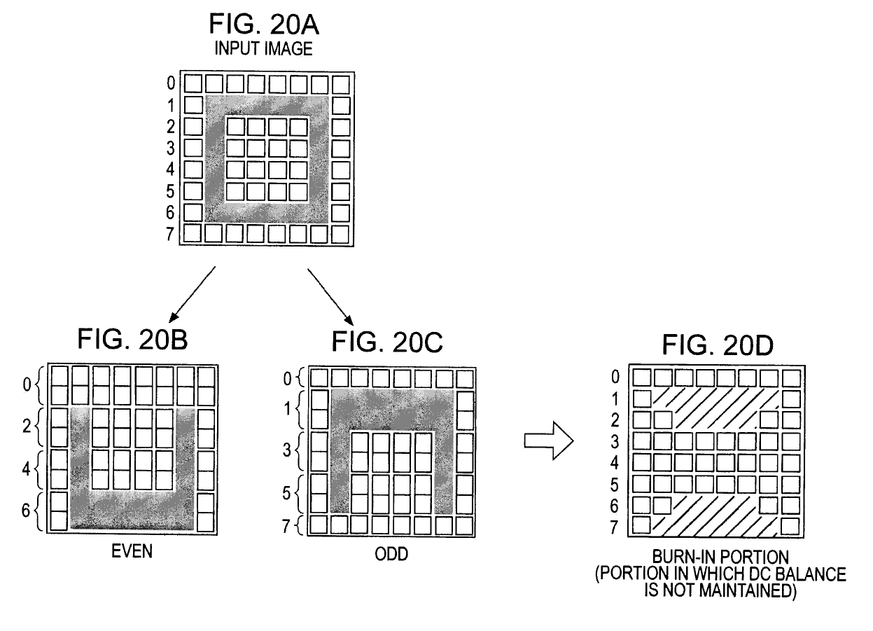

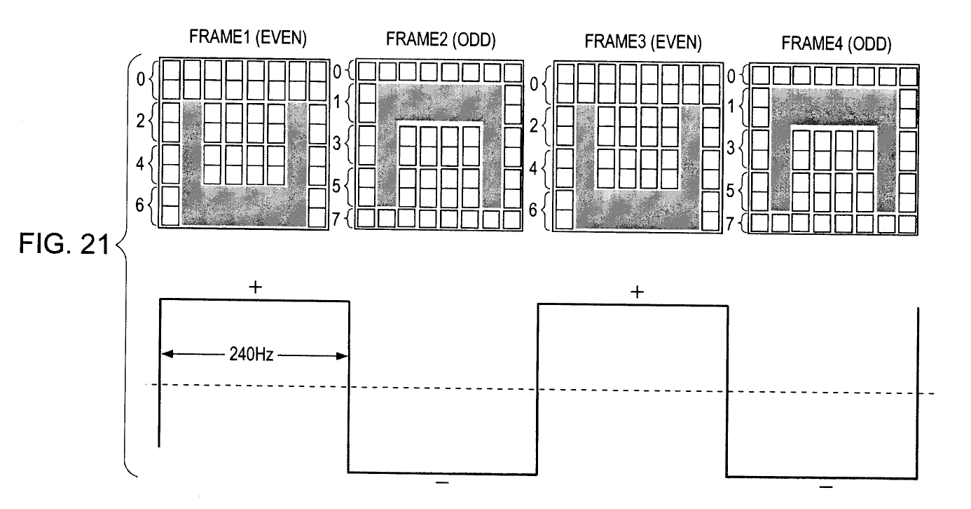

The achievement of both an increase in a frame rate and the suppression of the reduction in a resolution sensitivity in the vertical direction with a driving method according to the first embodiment of simultaneously driving two lines, changing combinations of two simultaneously driven lines, and switching between EVEN lines and ODD lines to be displayed will be considered with reference to FIGS. 20A to 21.

For example, when a method similar to a driving method according to the first embodiment is performed upon an input image illustrated in FIG. 20A, two types of display images illustrated in FIGS. 20B and 20C are generated. More specifically, FIG. 20B illustrates a display image generated when combinations of two simultaneously driven lines with which no redundant line is generated are used and each signal line is driven on the basis of image signals of extracted EVEN lines. FIG. 20C illustrates a display image generated when combinations of two simultaneously driven lines with which a redundant line is generated are used and each signal line is driven on the basis of image signals of extracted ODD lines (in this case, a signal value of a line 0 included in an input image is written into a redundant line having the smallest line number). For convenience of illustration, the numbers of pixels in an input image and a display image are 8×8. However, in reality, as described previously in the first embodiment, a large number of pixels, for example, 1920 pixels×1080 pixels, are included in an input image and a display image.

In the following description, a frame illustrated in FIG. 20B in which each signal line is driven on the basis of image signals of extracted EVEN lines is referred to as an EVEN frame, and a frame illustrated in FIG. 20C in which each signal line is driven on the basis of image signals of extracted ODD lines is referred to as an ODD frame.

As described previously, in the first embodiment, an EVEN frame and an ODD frame are alternately output for display in each frame period. FIG. 21 illustrates the transition of display image states of four frames, a frame 1 to a frame 4, along with a driving polarity for each frame when an EVEN frame and an ODD frame are alternately output for display in each frame period. FIG. 21 illustrates the change in a display image when the same input image illustrated in FIG. 20A is continuously obtained in four frames, that is, when the same still image is input in a four-frame period.

Thus, for example, even if a driving method according to the first embodiment is simply employed when a still image is input, like in the case of normal bipolar driving, it is difficult to perform the writing of the same image in both the positive polarity and the negative polarity. As a result, it is difficult to maintain a DC balance. This leads to the occurrence of burn-in (afterimage) in a portion in which a DC balance is not maintained. More specifically, burn-in occurs in a mismatching portion between the display image of an EVEN frame illustrated in FIG. 20B and the display image of an ODD frame illustrated in FIG. 20C, that is, in a diagonally shaded portion in FIG. 20D.

At the time of displaying a moving image, mismatching between a signal value of each pixel obtained in a driving period in which the positive polarity is used and a signal value of a corresponding pixel obtained in a driving period in which the negative polarity is used may similarly occur, and burn-in may similarly occur.

### [4-2. Driving Method According to Fourth Embodiment]

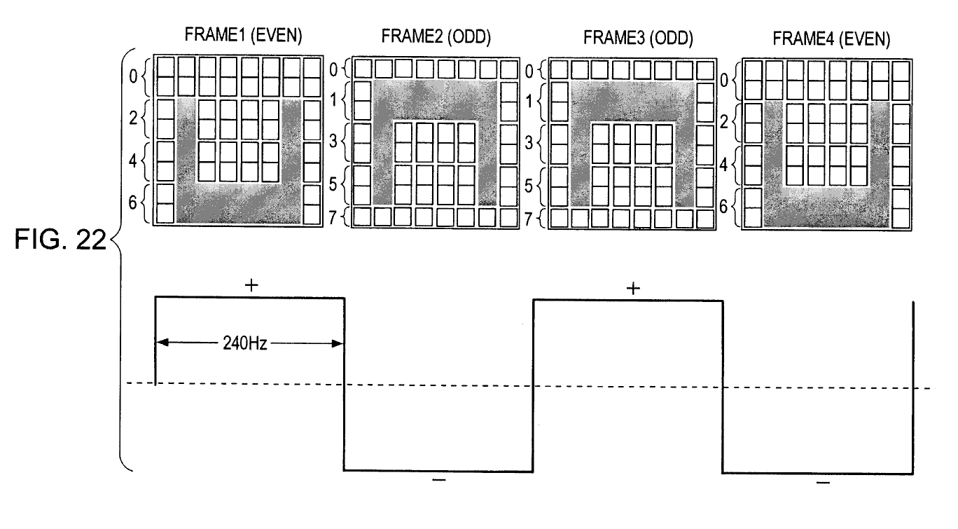

In the fourth embodiment, a bipolar driving method illustrated in FIG. 22 is proposed with which the occurrence of the above-described burn-in and the reduction in a resolution sensitivity in the vertical direction can be prevented and a frame rate can be increased. Like FIG. 21, FIG. 22 illustrates the change in a display image in a four-frame period in which the same still image is input.

As illustrated in FIG. 22, in the fourth embodiment, an EVEN frame and an ODD frame are not alternately used in each frame period. The switching between an EVEN frame and an ODD frame is performed between a first frame (frame 1) and a second frame (frame 2) included in a combination of four continuous frames and between a third frame (frame 3) and a fourth frame (frame 4) included in the combination of four continuous frames. That is, as illustrated in FIG. 22, when the combination of four continuous frames is set, a display image is changed as follows: the frame 1=an EVEN frame→the frame 2=an ODD frame→the frame 3=an ODD frame→the frame 4=an EVEN frame.

By performing such a driving method, it is possible to maintain a DC balance between the frames 1 and 4 included in the combination of four continuous frames and between the frames 2 and 3 included in the combination of four continuous frames when frame images among which high correlations are obtained, for example, a moving image with little motion that is practically the same as a still image, is input. That is, when correlations among frames are relatively high, using a driving method according to the fourth embodiment, it is possible to increase a frame rate and suppress the reduction in a resolution sensitivity in the vertical direction as compared with a case in which a normal bipolar driving method is performed. Furthermore, since a DC balance can be maintained using a driving method according to the fourth embodiment, it is possible to prevent the occurrence of burn-in.

Using the driving method according to the fourth embodiment illustrated in FIG. 22, unlike in the case illustrated in FIG. 19 in which a normal driving method is performed, it is unnecessary to output the same frame two times. Furthermore, since two lines are simultaneously scanned (in addition, EVEN lines or ODD lines are extracted and output), it is possible to reduce a time necessary for scanning of one frame by half and increase a frame rate by four times. For example, as described previously, if an input frame rate is 60 Hz (fps) when normal bipolar driving is performed, it is possible to increase the frame rate to 240 Hz (fps) in the fourth embodiment.

### [4-3. Configuration of Display Apparatus]

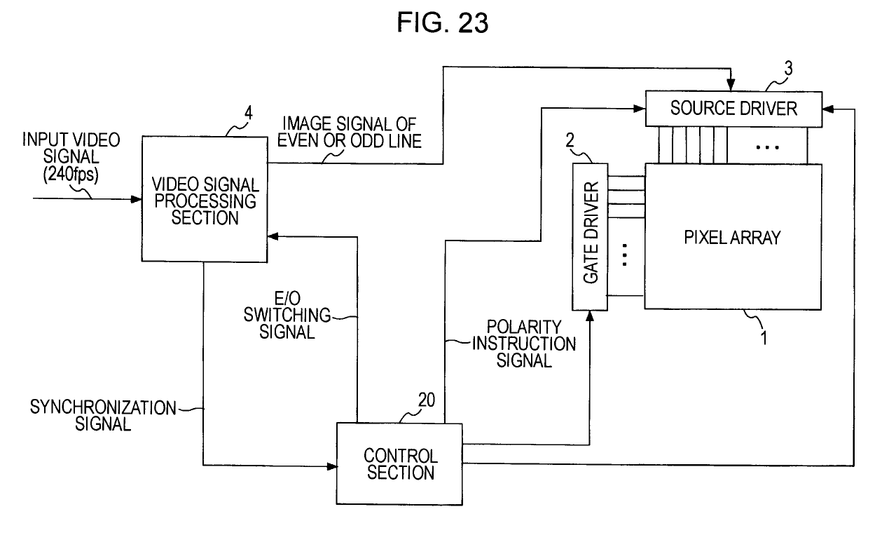

FIG. 23 is a diagram illustrating the internal configuration of a display apparatus according to the fourth embodiment for achieving the above-described driving method according to the fourth embodiment. A display apparatus according to the fourth embodiment differs from the display apparatus according to the first embodiment illustrated in FIG. 5 in that a control section 20 is used instead of the control section 5. Although not apparent from FIG. 23, the source driver 3 differs from the source driver 3 according to the first embodiment in that it is configured to drive each signal line in a polarity instructed by a polarity instruction signal transmitted from the control section 20 on the basis of an image output from the video signal processing section 4.

Like the control section 5 according to the first embodiment, the control section 20 included in a display apparatus according to the fourth embodiment causes the gate driver 2 to perform driving of each scanning line (including simultaneous driving of two lines and the change in combinations of simultaneously driven lines in each frame period) at a time based on a synchronization signal supplied from the video signal processing section 4 (the synchronization separation circuit 8) and controls a time at which the source driver 3 drives each signal line. In this embodiment, an E/O switching signal used for an EVEN/ODD switching instruction is similarly supplied to the video signal processing section 4 (the line thinning-out processing unit 6). The E/O switching signal generated by the control section 20 is not a signal used for an instruction for switching between an EVEN frame and an ODD frame in each frame period but a signal used for an instruction for performing switching between an EVEN frame and an ODD frame between a first frame and a second frame included in a combination of four continuous frames and between a third frame and a fourth frame included in the combination of four continuous frames.

The control section 20 generates on the basis of a synchronization signal supplied from the video signal processing section 4 a polarity instruction signal used for an instruction for alternately setting the positive polarity and the negative polarity in each frame period and supplies the polarity instruction signal to the source driver 3.

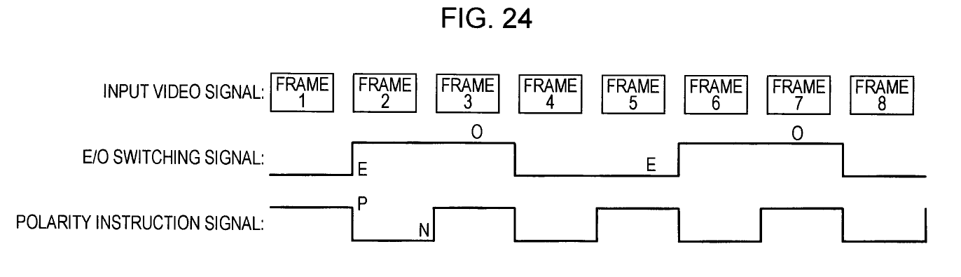

FIG. 24 illustrates the relationship among a time at which each frame is displayed, the waveform of an E/O switching signal, and the waveform of a polarity instruction signal when driving is performed under the control of the control section 20. For convenience of illustration, FIG. 24 illustrates the relationship among a time at which each frame is displayed, the waveform of an E/O switching signal, and the waveform of a polarity instruction signal in a period of eight frames, a frame 1 to a frame 8. As illustrated in FIG. 24, an E/O switching signal used for an EVEN instruction is generated in display periods of the frames 1, 4, 5, and 8, and an E/O switching signal used for an ODD instruction is generated in display periods of the frames 2, 3, 6, and 7. A polarity instruction signal is generated so that the positive polarity and the negative polarity are alternately set in each frame period starting from the positive polarity in the display period of the frame 1.

### 5. Fifth Embodiment

### [5-1. Driving Method According to Fifth Embodiment]

According to the fourth embodiment, it is possible to increase a frame rate and maintain a DC balance when input frame images among which relatively high correlations are obtained are displayed. However, when frame images among which relatively low correlations are obtained, for example, a moving image with relatively fast motion, are input, it is difficult to maintain a DC balance. The bipolar driving method illustrated in FIG. 19 is effective to maintain a DC balance in input images having any characteristic. However, in this case, it is difficult to increase a frame rate. In the fifth embodiment, a method will be proposed capable of increasing a frame rate and maintaining a perfect DC balance obtained when normal bipolar driving is performed.

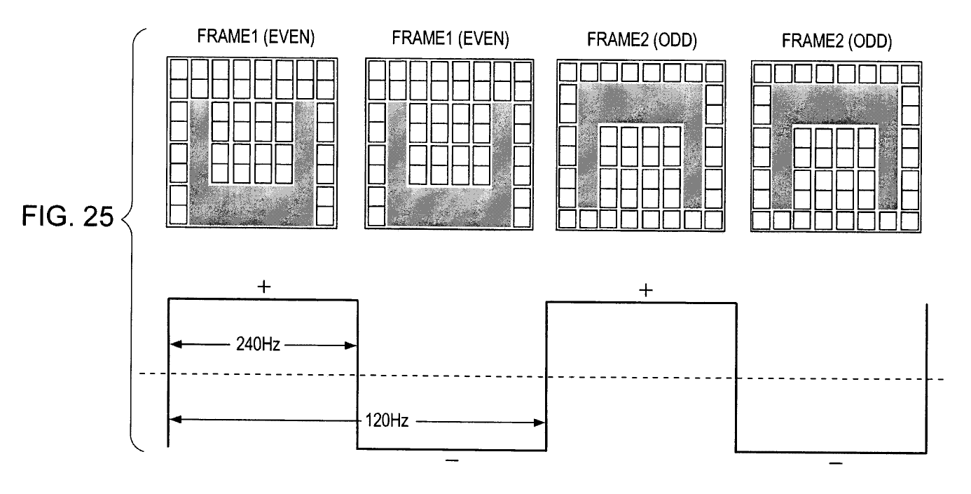

FIG. 25 is a diagram describing a driving method according to the fifth embodiment and illustrates the relationship between a display image and a driving polarity. As is apparent from FIG. 25, like in a normal bipolar driving method, in a driving method according to the fifth embodiment, the same frame is output two times. At the time of first output of the frame, driving in the positive polarity is performed. At the time of second output of the frame, driving in the negative polarity is performed.

A driving method according to the fifth embodiment differs from a normal bipolar driving method in that an EVEN frame or an ODD frame is used at the time of displaying each frame to reduce a scanning time. That is, it is possible to double a frame rate from that in the related art by using an EVEN frame or an ODD frame.

At that time, as illustrated in FIG. 25, the switching between an EVEN frame and an ODD frame is not performed in a period in which the same frame is displayed (a scanning period of one frame×2), and is performed when a display frame is changed. That is, from the viewpoint of scanning, the switching between an EVEN frame and an ODD frame is performed each time the scanning of the same frame is performed two times.

Thus, in the fifth embodiment, the first scanning and second scanning of the same frame image (a frame image having the same number) are individually performed in the positive driving polarity and the negative driving polarity and the switching between an EVEN frame and an ODD frame is performed each time the first scanning and second scanning of the same frame image are performed. Using a driving method according to the fifth embodiment, like in a case where a normal bipolar driving method is employed, it is possible to perform driving (writing) of the same image in both the positive polarity and the negative polarity and maintain a perfect DC balance in any of input images including a moving image with fast motion. Furthermore, in the fifth embodiment, like in the first embodiment, since a time length necessary for scanning of one frame is reduced by half by applying the display and output of an EVEN frame/an ODD frame, it is possible to double a frame rate from that obtained when a normal bipolar driving method is performed. This leads to the improvement in moving image quality. As is apparent from FIG. 25, using a driving method according to the fifth embodiment, since an EVEN frame and an ODD frame are alternately used each time a frame image is changed (that is, between the frame 1 and the frame 2), it is possible to achieve a scanning method, for example, the interlacing display method, like in the first embodiment. As a result, it is possible to suppress the reduction in a resolution sensitivity in the vertical direction. This leads to the improvement in moving image quality.

### [5-2. Configuration of Display Apparatus]

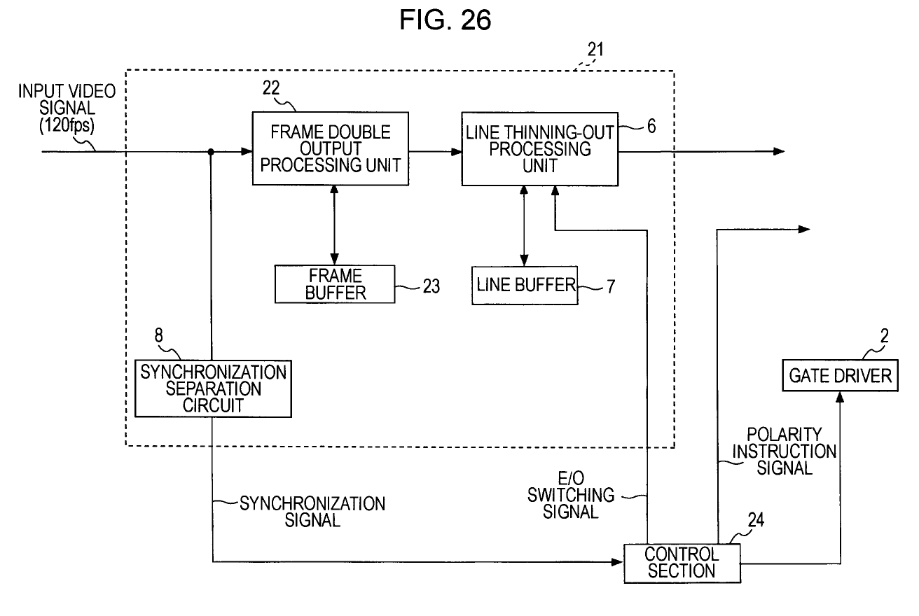

The configuration of a display apparatus according to the fifth embodiment for achieving the above-described driving method according to the fifth embodiment will be described with reference to FIG. 26. The internal configuration of a display apparatus according to the fifth embodiment differs from that of a display apparatus according to the fourth embodiment illustrated in FIG. 23 in that a video signal processing section 21 and a control section 24 are used instead of the video signal processing section 4 and the control section 20, respectively. Accordingly, in FIG. 26, the internal configuration of the video signal processing section 21 included in a display apparatus according to the fifth embodiment and the control section 24 are illustrated and the illustration and description of the entire internal configuration of the display apparatus are omitted.

As described previously, in this case, since it is possible to double a frame rate from that (60 fps) obtained when a bipolar driving method in the related art is performed, an input video signal of 120 fps is input into the video signal processing section 21 as illustrated in FIG. 26.

The video signal processing section 21 includes the synchronization separation circuit 8, a frame double output processing unit 22, a frame buffer 23, the line thinning-out processing unit 6, and the line buffer 7. In the video signal processing section 21, the input video signal is supplied to the synchronization separation circuit 8 and the frame double output processing unit 22.

In the video signal processing section 21, the frame double output processing unit 22, the frame buffer 23, the line thinning-out processing unit 6, and the line buffer 7 function as a line thinning-out and double output processing unit for continuously outputting two times a result of extraction of image signals of even-numbered horizontal lines or odd-numbered horizontal lines included in a frame image signal obtained from an input video signal.

More specifically, the frame double output processing unit 22 stores a frame image signal obtained from the input video signal in the frame buffer 23 and outputs the frame image signal two times. The frame image signals output by the frame double output processing unit 22 are supplied to the line thinning-out processing unit 6. As describe previously with reference to FIG. 6, the line thinning-out processing unit 6 extracts image signals of EVEN lines from the received frame image signals and outputs them or extracts image signals of ODD lines and a line 0 from the received frame image signals and outputs them using the line buffer 7 on the basis of an E/O switching signal supplied from the control section 24.

Like the control section 20 described in the fourth embodiment, the control section 24 controls a time at which the gate driver 2 drives each scanning line and a time at which the source driver 3 (not illustrated) drives each signal line using timing signals. Furthermore, the control section 24 supplies a polarity instruction signal for specifying a polarity used for driving of a signal line to the source driver 3. A cycle in which the control section 20 according to the fourth embodiment transmits an EVEN/ODD switching instruction with an E/O switching signal and a cycle in which the control section 20 according to the fourth embodiment instructs the gate driver 2 to change combinations of two simultaneously driven lines are different from a cycle in which the control section 24 according to the fifth embodiment transmits an EVEN/ODD switching instruction with an E/O switching signal and a cycle in which the control section 24 according to the fifth embodiment instructs the gate driver 2 to change combinations of two simultaneously driven lines, respectively. Specifically, an E/O switching signal is generated and output every double scanning of the same frame image. More specifically, an EVEN/ODD switching instruction signal is generated and output in a frame period specified by a synchronization signal supplied from the synchronization separation circuit 8 (that is, in a frame period of an input video signal).

Information used for an instruction for changing combinations of two simultaneously driven lines every double scanning of the same frame image, that is, in each frame period specified by the synchronization signal, is similarly supplied to the gate driver 2.

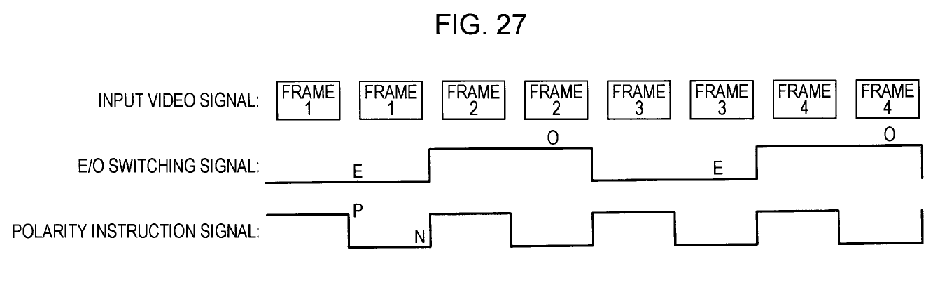

FIG. 27 illustrates the relationship among a time at which each frame is displayed, the waveform of an E/O switching signal, and the waveform of a polarity instruction signal when driving is performed under the control of the control section 24. For convenience of illustration, FIG. 27 illustrates the relationship among a time at which each frame is displayed, the waveform of an E/O switching signal, and the waveform of a polarity instruction signal in a period of four frames, a frame 1 to a frame 4. As illustrated in FIG. 27, an E/O switching signal is generated and output as an EVEN/ODD switching instruction signal every double scanning of the same frame image (the frame 1, 2, 3, or 4). On the other hand, a polarity instruction signal is generated and output as a signal used for an instruction for switching between the positive polarity and the negative polarity in each period half that of an E/O switching signal.

### 6. Sixth Embodiment

### [6-1. Driving Method According to Sixth Embodiment]

In the sixth embodiment, the switching between a driving method according to the fourth embodiment and a driving method according to the fifth embodiment is performed in accordance with characteristics of an input image. That is, in order to prevent the occurrence of burn-in by maintaining a perfect DC balance when, for example, a moving image with fast motion is input and improve moving image quality by increasing a frame rate when an image on which burn-in may not occur is input, the switching between a driving method according to the fourth embodiment and a driving method according to the fifth embodiment is performed as described previously.

In the sixth embodiment, in addition to the switching between a driving method according to the fourth embodiment and a driving method according to the fifth embodiment, the switching from the simultaneous driving of a plurality of lines to normal bipolar driving (that is, a frame is output two times and lines are sequentially driven one by one) is performed when an input image can be determined to be a still image. Thus, by also performing the switching to normal bipolar driving when a still image is input, it is possible to obtain the highest resolution (in the vertical direction). At the same time, by simultaneously driving a plurality of lines when a moving image is input, it is possible to increase a frame rate (that is, to improve moving image quality).

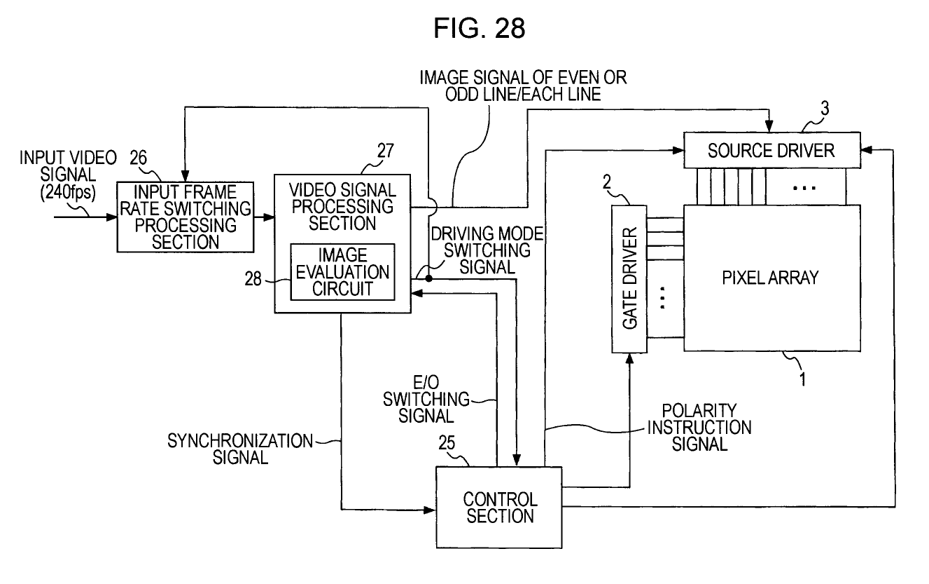

A driving method according to the sixth embodiment will be described in detail below. In the sixth embodiment, an image evaluation circuit 28 illustrated in FIG. 28 is disposed for determining whether an input video signal (input frame images) is a signal of an image that can be determined to be a still image (very high correlations are obtained among frames), a signal of a moving image with relatively little motion (relatively high correlations are obtained among frames), or a signal of a moving image with relatively fast motion (relatively low correlations are obtained among frames). When the image evaluation circuit 28 determines that an input image is a still image, normal bipolar driving is performed. When the image evaluation circuit 28 determines that an input image is a moving image with relatively little motion, a driving method according to the fourth embodiment is performed, that is, a display image is changed as follows: the frame 1=an EVEN frame→the frame 2=an ODD frame→the frame 3=an ODD frame→the frame 4=an EVEN frame. When the image evaluation circuit 28 determines that an input image is a moving image with relatively fast motion, a driving method according to the fifth embodiment is performed, that is, a display image is changed as follows: the frame 1=an EVEN frame→the frame 1=an EVEN frame→the frame 2=an ODD frame→the frame 2=an ODD frame.

For convenience of explanation, a mode in which a driving method according to the fourth embodiment, a mode in which a driving method according to the fifth embodiment is performed, and a mode in which normal bipolar driving is performed are hereinafter referred to as a moving image quality priority mode, a DC balance guarantee mode, and a resolution priority mode, respectively.

As described previously, using a driving method according to the sixth embodiment of switching among the moving image quality priority mode, the DC balance guarantee mode, and the resolution priority mode, it is possible to prevent the reduction in a resolution sensitivity when a still image is input, improve moving image quality by increasing a frame rate when a moving image is input, and prevent the occurrence of burn-in by maintaining a DC balance as compared with a case in which only normal bipolar driving is performed.

### [6-2. Configuration of Display Apparatus]

FIG. 28 illustrates the internal configuration of a display apparatus according to the sixth embodiment for achieving the above-described driving method according to the sixth embodiment. As illustrated in FIG. 28, like a display apparatus according to the fourth embodiment illustrated in FIG. 23, a display apparatus according to the sixth embodiment includes the pixel array 1, the gate driver 2, and the source driver 3. In addition, a display apparatus according to the sixth embodiment includes a control section 25, an input frame rate switching processing section 26, and a video signal processing section 27.

For example, when a frame rate at the time of normal bipolar driving is 60 Hz, the switching among a normal bipolar driving method, a driving method according to the fourth embodiment, and a driving method according to the fifth embodiment is equivalent to the switching among frame rates of 60 Hz, 240 Hz, and 120 Hz (see, FIGS. 19, 22, and 25). Accordingly, a display apparatus according to the sixth embodiment includes the input frame rate switching processing section 26 so as to switch among these frame rates of input video signals in response to the switching among the three driving modes.

In this case, the frame rate of an input video signal is set to a frame rate for a driving method according to the fourth embodiment (the moving image quality priority mode) with which the highest frame rate is achieved. That is, since it is assumed that a frame rate at the time of normal bipolar driving is 60 fps, the frame rate of an input video signal supplied to the input frame rate switching processing section 26 is set to 240 fps as illustrated in FIG. 28.

The input frame rate switching processing section 26 changes the frame rate of an input video signal on the basis of a driving mode switching signal output by the image evaluation circuit 28 to be described later which is used for an instruction for switching among the moving image quality priority mode, the DC balance guarantee mode, and the resolution priority mode. More specifically, when the input frame rate switching processing section 26 is instructed to set the DC balance guarantee mode by the driving mode switching signal, it groups frame images obtained from the input video signal into combinations of two frame images adjacent to each other in a time axial direction, calculates an average of signal values of the two frame images included in each of the combinations of two frame images, and obtains one frame image from each of the combinations of two frame images. That is, the frame rate of the input video signal is reduced by half (the switching from 240 fps to 120 fps). The input frame rate switching processing section 26 also adjusts a synchronization signal in accordance with the switching between frame rates.

When the input frame rate switching processing section 26 is instructed to set the resolution priority mode by the driving mode switching signal, it groups frame images obtained from the input video signal into combinations of four continuous frame images, calculates an average of signal values of the four frame images included in each of the combinations of four frame images, and obtains one frame image from each of the combinations of four frame images. That is, the frame rate of the input video signal is reduced by one-fourth (the switching from 240 fps to 60 fps).

When the input frame rate switching processing section 26 is instructed to set the moving image quality priority mode by the driving mode switching signal, it outputs the input video signal without processing the input video signal.

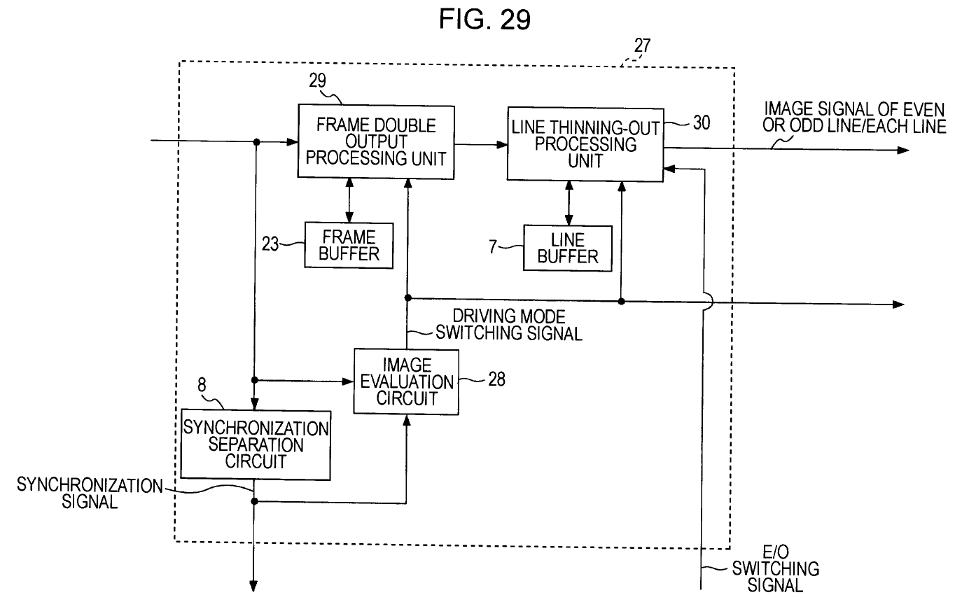

The video signal processing section 27 receives the input video signal transmitted via the input frame rate switching processing section 26. FIG. 29 illustrates the internal configuration of the video signal processing section 27. As illustrated in FIG. 29, the video signal processing section 27 includes the synchronization separation circuit 8, a frame double output processing unit 29, the frame buffer 23, a line thinning-out processing unit 30, the line buffer 7, and the image evaluation circuit 28.

Referring to FIG. 29, the input video signal is transmitted to the synchronization separation circuit 8, the frame double output processing unit 29, and the image evaluation circuit 28 via the input frame rate switching processing section 26. Like the frame double output processing unit 22 illustrated in FIG. 26, the frame double output processing unit 29 outputs the same frame image obtained from the input video signal two times using the frame buffer 23. The difference between the frame double output processing unit 22 and the frame double output processing unit 29 is that the frame double output processing unit 29 switches between the double output of a frame image and the normal output of a frame image on the basis of a driving mode switching signal supplied from the image evaluation circuit 28. More specifically, when the frame double output processing unit 29 is instructed to set the moving image quality priority mode by the driving mode switching signal, it does not perform the double output of the same frame image and sequentially outputs frame images one by one as usual. On the other hand, when the frame double output processing unit 29 is instructed to set the DC balance guarantee mode or the resolution priority mode by the driving mode switching signal, it performs the double output of the same frame image using the frame buffer 23.

A frame image output from the frame double output processing unit 29 is supplied to the line thinning-out processing unit 30. Like the line thinning-out processing unit 6 illustrated in FIG. 6, the line thinning-out processing unit 30 performs the extraction and output of EVEN lines or ODD lines (and a line 0) using the line buffer 7 on the basis of an E/O switching signal. The difference between the line thinning-out processing unit 6 and the line thinning-out processing unit 30 is that the line thinning-out processing unit 30 switches between line extraction and output processing and normal output processing on the basis of a driving mode switching signal transmitted from the image evaluation circuit 28. That is, when the line thinning-out processing unit 30 is instructed to set the DC balance guarantee mode or the moving image quality priority mode by the driving mode switching signal, it performs the extraction and output of EVEN lines or ODD lines (and the line 0) on the basis of an E/O switching signal. On the other hand, when the line thinning-out processing unit 30 is instructed to set the resolution priority mode by the driving mode switching signal, it performs the normal output processing, that is, outputs the input frame image without processing the input frame image.

Referring to FIG. 29, a synchronization signal output from the synchronization separation circuit 8 is supplied to the control section 25 illustrated in FIG. 28 and the image evaluation circuit 28. The image evaluation circuit 28 evaluates the correlation between input frame images on the basis of the input video signal transmitted via the input frame rate switching processing section 26 and the synchronization signal and outputs a driving mode switching signal used for an instruction for setting one of the resolution priority mode, the DC balance guarantee mode, and the moving image quality priority mode on the basis of a result of the evaluation.

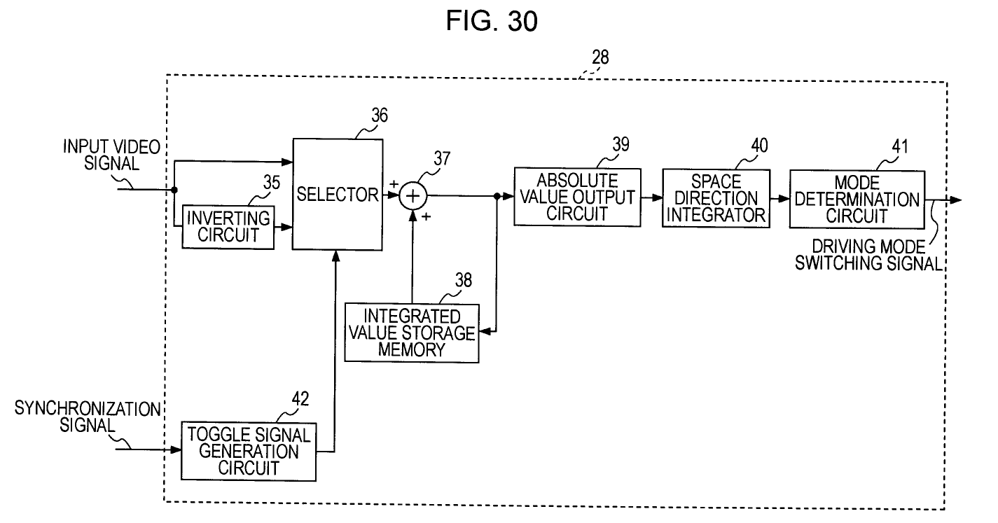

FIG. 30 illustrates the internal configuration of the image evaluation circuit 28. As illustrated in FIG. 30, the image evaluation circuit 28 includes an inverting circuit 35, a selector 36, an adder 37, an integrated value storage memory 38, an absolute value output circuit 39, a space direction integrator 40, a mode determination circuit 41, and a toggle signal generation circuit 42.

In the image evaluation circuit 28, the input video signal transmitted via the input frame rate switching processing section 26 is supplied to the inverting circuit 35 and the selector 36 as illustrated in FIG. 30. The input video signal is subjected to polarity inversion performed by the inverting circuit 35 and is then supplied to the selector 36. The synchronization signal transmitted from the synchronization separation circuit 8 illustrated in FIG. 29 is supplied to the toggle signal generation circuit 42 included in the image evaluation circuit 28. The toggle signal generation circuit 42 generates a toggle signal synchronized with a frame period for each frame on the basis of the synchronization signal (vertical synchronization signal) and supplies the toggle signal to the selector 36.

The inverting circuit 35, the selector 36, the adder 37, and the integrated value storage memory 38 are disposed so as to integrate signal values at each pixel position in input frame images. For convenience of illustration, only a single combination of the inverting circuit 35, the selector 36, and the adder 37 (that is, a combination of the inverting circuit 35, the selector 36, and the adder 37 for only a single pixel) is illustrated. In reality, however, a plurality of combinations of the inverting circuit 35, the selector 36, and the adder 37 are disposed and an integrated value at each pixel position in input frame images is stored in the integrated value storage memory 38. Alternatively, when a plurality of pixels in an input frame image are set as one unit, the combination of the inverting circuit 35, the selector 36, and the adder 37 is disposed for each unit of pixels. In this case, the calculations of integrated values at the positions of these pixels included in each unit may be time-divisionally performed. When enough processing power is provided for a single combination of the inverting circuit 35, the selector 36, and the adder 37, the combination of the inverting circuit 35, the selector 36, and the adder 37 may time-divisionally perform the calculations of integrated values at the positions of all pixels in input frame images. An exemplary case in which a combination of the inverting circuit 35, the selector 36, and the adder 37 is disposed for each pixel will be described.

The selector 36 alternately outputs to the adder 37 the input video signal and the input video signal the polarity of which has been inverted by the inverting circuit 35 in each period represented by the toggle signal that has been generated for each frame (that is, in each frame period). The adder 37 adds the integrated value of a certain single pixel stored in the integrated value storage memory 38 and the signal value of a corresponding pixel included in the input video signal (input frame image) supplied from the selector 36. A result of the addition performed by the adder 37 is stored in the integrated value storage memory 38 as an integrated value at the position of a corresponding pixel and is supplied to the absolute value output circuit 39.

The inverting circuit 35, the selector 36, an adder 37, the integrated value storage memory 38, and the toggle signal generation circuit 42 alternately perform the addition of a non-inverted value of a signal value at each pixel position and the addition of an inverted value of a signal value at each pixel position. That is, when a value output from an integrator for integrating signal values at each pixel position which is formed of the adder 37 (the adders 37 in reality) and the integrated value storage memory 38 is, for example, zero, this means that the correlation between frame images is the highest. The larger the value output from the integrator, the lower the correlation between frame images. That is, an output value of the integrator can be used as an indicator of the correlation between frame images.

However, since the output value of the integrator is a value obtained at each pixel position, it is difficult to use the output value as an evaluation indicator. Accordingly, in this exemplary case, the absolute value output circuit 39 and the space direction integrator 40 are disposed so that a single value can be obtained as an evaluation indicator of the correlation between frame images.

The absolute value output circuit 39 outputs the absolute value of an integrated value at each pixel position supplied from the integrator formed of the adder 37 and the integrated value storage memory 38.

The space direction integrator 40 receives from the absolute value output circuit 39 the absolute value of an integrated value at each pixel position and adds these absolute values in a space direction. More specifically, the space direction integrator 40 adds all of the absolute values of integrated values at pixel positions. An integrated value in the space direction obtained by the space direction integrator 40 is supplied to the mode determination circuit 41.

On the basis of a predetermined first threshold value Th1 and a predetermined second threshold value Th2, which are set in advance, and the integrated value in the space direction, the mode determination circuit 41 determines which of the resolution priority mode, the moving image quality priority mode, and the DC balance guarantee mode will be set in accordance with the correlation between input frame images. More specifically, when the integrated value in the space direction output from the space direction integrator 40 is equal to or larger than zero and is smaller than the first threshold value Th1, the mode determination circuit 41 determines that an input image is a still image and outputs a driving mode switching signal used for an instruction for setting the resolution priority mode. When the integrated value in the space direction output from the space direction integrator 40 is equal to or larger than the first threshold value Th1 and is smaller than the second threshold value Th2, the mode determination circuit 41 determines that the correlation between frame images is relatively high and outputs a driving mode switching signal used for an instruction for setting the moving image quality priority mode. When the integrated value in the space direction output from the space direction integrator 40 is equal to or larger than the second threshold value Th2, the mode determination circuit 41 determines that the correlation between frame images is relatively low and outputs a driving mode switching signal used for an instruction for setting the DC balance guarantee mode.

Referring back to FIG. 28, the driving mode switching signal output from the image evaluation circuit 28 is supplied to the control section 25 as illustrated in the drawing. In order to achieve a driving mode represented by the driving mode switching signal, the control section 25 outputs an E/O switching signal used for an EVEN/ODD instruction, a polarity instruction signal that is a driving polarity switching time instruction, an instruction for causing the gate driver 2 to change combinations of two simultaneously driven lines, and an instruction for causing the gate driver 2 to switch between simultaneous driving of two lines and sequential scanning of scanning lines.

More specifically, when the control section 25 is instructed to set the resolution priority mode by the driving mode switching signal, it transmits to the gate driver 2 information used to instruct the gate driver 2 to sequentially drive scanning lines (that is, sequential driving of scanning lines). When the control section 25 is instructed to set the DC balance guarantee mode, it transmits to the gate driver 2 information used to instruct the gate driver 2 to change combinations of two lines every double scanning of the same frame image. When the control section 25 is instructed to set the moving image quality priority mode, it transmits to the gate driver 2 information used to instruct the gate driver 2 to change combinations of two simultaneously driven lines in each frame period. The gate driver 2 according to the sixth embodiment is configured to switch between simultaneous driving of two lines and driving of each line in response to the instruction transmitted from the control section 25.

When the control section 25 is instructed to set the DC balance guarantee mode, it generates and outputs an E/O switching signal used for an instruction for switching between EVEN and ODD in each frame period (frame period of an input image). When the control section 25 is instructed to set the moving image quality priority mode, it generates and outputs an E/O switching signal used for an instruction for switching between EVEN and ODD between a first frame and a second frame included in a combination of four continuous frames and between a third frame and a fourth frame included in the combination of four continuous frames.

When the control section 25 is instructed to set the resolution priority mode and the DC balance guarantee mode, it generates and outputs a polarity instruction signal used for an instruction for switching between the positive polarity and the negative polarity in each period half a frame period (the frame period of an input image). When the control section 25 is instructed to set the moving image quality priority mode, it generates and outputs a polarity instruction signal used for an instruction for switching between the positive polarity and the negative polarity in each frame period.

### 7. Modification

Although the embodiments of the present invention have been described, the present invention is not limited thereto. For example, although it is assumed that a frame rate at the time of normal driving is 60 fps in the embodiments of the present invention, the value of the frame rate is not limited thereto. The number of pixels included in a panel is not limited to 1920×1080 described previously as an example, and may be changed to, for example, 4096×2160 or 8192×4320.

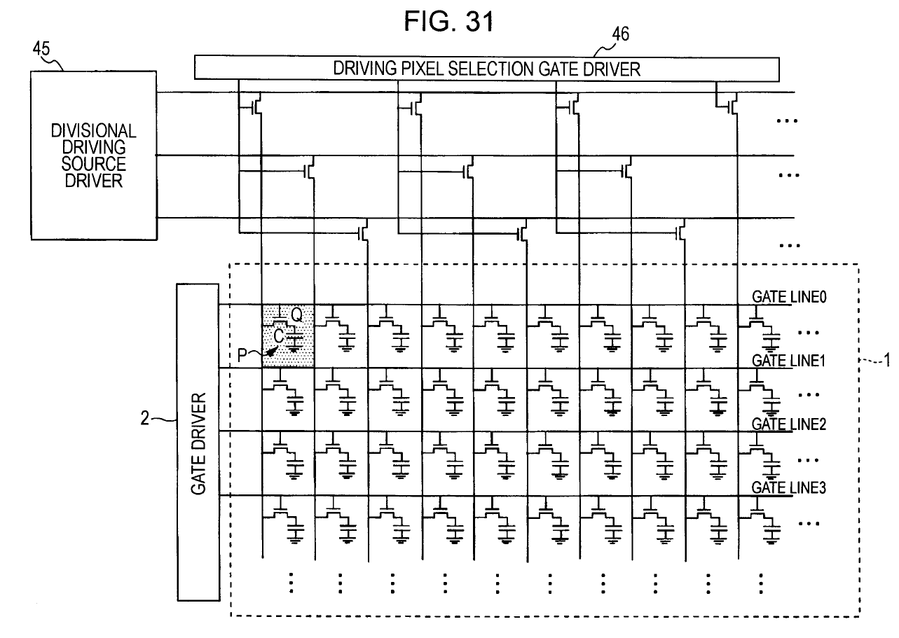

In the embodiments of the present invention, the source driver 3 simply drives each signal line. However, for example, as illustrated in FIG. 31, signal lines may be grouped into combinations of a predetermined number of signal lines and signal line driving may be performed in units of combinations of a predetermined number of signal lines. A signal line divisional driving method illustrated in FIG. 31 is applied to, for example, SXRD panels and LCOS panels.

Referring to FIG. 31, the pixel array 1 and the gate driver 2 have the same configurations as those described in the embodiments of the present invention. Instead of the source driver 3 for simply driving signal lines, a divisional driving source driver 45 and a driving pixel selection gate driver 46 are disposed. In order to allow the divisional driving source driver 45 and the driving pixel selection gate driver 46 to sequentially drive combinations of a predetermined number (hereinafter referred to as m, and m=3 in FIG. 31) of signal lines, each signal line has a switching element (an FET in this case) for selecting a combination of m signal lines into which a signal can be written (that is, for bringing a certain combination of m signal lines into an active state or a non-active state. As illustrated in FIG. 31, a switching element has a drain connected to a signal line and a source connected to the divisional driving source driver 45. At that time, as illustrated in FIG. 31, the sources of first ones of m switching elements included in combinations of m signal lines are connected to the divisional driving source driver 45 via a common line, the sources of second ones of m switching elements included in the combinations of m signal lines are connected to the divisional driving source driver 45 via a common line, and the sources of m-th ones of m switching elements included in the combinations of m signal lines are connected to the divisional driving source driver 45 via a common line. The gates of the m switching elements included in each of the combinations of m signal lines are connected to the driving pixel selection gate driver 46 via a common line.

In a display apparatus having the above-described configuration, driving of signal lines in a period of one horizontal line is performed as follows. That is, the driving pixel selection gate driver 46 sequentially selects signal lines into which a signal value is written by the divisional driving source driver 45 by sequentially turning on m switching elements included in each of combinations of m signal lines. When an image signal of one horizontal line is input, the divisional driving source driver 45 individually drives m signal lines selected by the driving pixel selection gate driver 46 with signal values at pixel positions corresponding to these signal lines. As a result, a signal value is sequentially written into m signal lines included in each of combinations of m signal lines. Accordingly, it is unnecessary to provide the same number of lines extending from a source driver as that of signal lines included in the pixel array 1, and it is possible to reduce the number of lines extending from the source driver to m. This is advantageous for a line layout.

In the above description, only when bipolar driving is performed, the switching between driving modes is performed. However, for example, the following mode switching may be performed: the switching between a driving method according to the first embodiment and a normal driving method (in which lines are sequentially scanned and EVEN/ODD thinning-out is not performed); and the switching between a driving method according to the second embodiment and a normal driving method (in which lines are sequentially scanned in each area and EVEN/ODD thinning-out is not performed). The normal driving method corresponds to the resolution priority mode described in the sixth embodiment. Accordingly, in this case, an evaluation unit such as the image evaluation circuit 28 for determining whether an input image is a moving image or a still image is also disposed. When an input image is a still image, the normal driving method is performed. When an input image is a moving image, a driving method according to the first embodiment and a driving method according to the second embodiment are performed. As a result, it is possible to improve image quality at the time of displaying the still image by ensuring a resolution and improve image quality at the time of displaying the moving image by increasing a frame rate. Consequently, regardless of whether a moving image or a still image is input, it is possible to achieve high image quality.

In the third, fourth, fifth, and sixth embodiments, the area divisional driving method described in the second embodiment may be performed.

In the above description, the present invention is applied to display driving of a liquid crystal panel. However, for example, the present invention may be applied to display driving of another flat-panel display (FPD) such as an organic EL display.

The present application contains subject matter related to that disclosed in Japanese Priority Patent Application JP 2009-120729 filed in the Japan Patent Office on May 19, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus for controlling a display panel unit including a display unit having a plurality of scanning lines and a plurality of signal lines, a scanning line driving unit for selecting a horizontal line into which signals are written at the time of driving the plurality of signal lines by driving one of the plurality of scanning lines included in the display unit, and a signal line driving unit for causing the display unit to display an image by driving the plurality of signal lines on the basis of an input image signal, the display control apparatus comprising,
a scanning control unit configured to control the scanning line driving unit so that a plurality of adjacent scanning lines are simultaneously driven in a horizontal line period in which an image signal of one horizontal line is output for display and the same pixel value is written into a plurality of adjacent pixels, and to control the scanning line driving unit so that combinations of a plurality of simultaneously driven scanning lines are changed in each period corresponding to a frame period of the input image signal.

2. The display control apparatus according to claim 1, further comprising a line thinning-out processing unit configured to extract even-numbered horizontal lines or odd-numbered horizontal lines from a frame image obtained from an input video signal and output the extracted even-numbered horizontal lines or odd-numbered horizontal lines to the signal line driving unit, and
wherein the scanning control unit controls the scanning line driving unit so that the combinations of the plurality of simultaneously driven scanning lines are changed in each frame period, and
wherein the display control apparatus further includes a first even/odd-numbered line output switching control unit configured to control the line thinning-out processing unit so that the even-numbered horizontal lines and the odd-numbered horizontal lines are alternately output in each frame period.

3. The display control apparatus according to claim 2,
wherein a plurality of display areas are set in the display unit, and the plurality of display areas are independently subjected to scanning line driving performed by the scanning line driving unit and signal line driving performed by the signal line driving unit,
wherein the display control apparatus further includes an image dividing processing unit configured to divide a frame image signal obtained from the input video signal into image signals for the plurality of display areas,
wherein the line thinning-out processing unit performs line thinning-out processing upon each of the image signals for the plurality of display areas obtained by the image dividing processing unit and outputs a result of the line thinning-out processing to the signal line driving unit, and
wherein the scanning control unit controls the scanning line driving unit so that, in each of the plurality of display areas, the plurality of adjacent scanning lines are simultaneously driven in the horizontal line period in which an image signal of one horizontal line is output for display and the combinations of the plurality of simultaneously driven scanning lines are changed in each frame period.

4. The display control apparatus according to claim 1,
wherein the display unit has the plurality of scanning lines the number of which is twice the number of horizontal lines in the frame image obtained from the input video signal,
wherein the display control apparatus further includes a normal output/average output switching processing unit configured to switch between normal output processing for sequentially outputting to the signal line driving unit image signals of horizontal lines included in the frame image obtained from the input video signal and average output processing for grouping the horizontal lines included in the frame image into combinations of two adjacent horizontal lines, calculating an average of image signal values of two adjacent horizontal lines included in each of the combinations of two adjacent horizontal lines on a pixel-by-pixel basis, and outputting a result of the calculation to the signal line driving unit, and
wherein the scanning control unit controls the scanning line driving unit so that the combinations of the plurality of simultaneously driven scanning lines are changed in each frame period.

5. The display control apparatus according to claim 1, further comprising a driving polarity control unit configured to control the signal line driving unit so that a positive polarity and a negative polarity are alternately used for driving of the plurality of signal lines performed by the signal line driving unit.

6. The display control apparatus according to claim 5, further comprising the line thinning-out processing unit configured to extract even-numbered horizontal lines or odd-numbered horizontal lines from the frame image obtained from the input video signal and output the extracted even-numbered horizontal lines or odd-numbered horizontal lines to the signal line driving unit, and
wherein the scanning control unit controls the scanning line driving unit so that, when combinations of four continuous frame images are set, the combinations of the plurality of simultaneously driven scanning lines are changed between display times of a first frame image and a second frame image included in each of the combinations of four continuous frame images and between display times of a third frame image and a fourth frame image, and
wherein the display control apparatus further includes a second even/odd-numbered line output switching control unit configured to control the line thinning-out processing unit so that the line thinning-out processing unit performs switching between even-numbered horizontal line output processing and odd-numbered horizontal line output processing between the display times of the first frame image and the second frame image and between the display times of the third frame image and the fourth frame image.

7. The display control apparatus according to claim 5, further comprising a line thinning-out and double output processing unit configured to continuously output to the signal line driving unit two times a result of extraction of even-numbered horizontal lines or odd-numbered horizontal lines from the frame image obtained from the input video signal, and
wherein the scanning control unit controls the scanning line driving unit so that the combinations of the plurality of simultaneously driven scanning lines are changed each time scanning of one frame is performed two times, and
wherein the display control apparatus further includes a third even/odd-numbered line output switching control unit configured to control the line thinning-out and double output processing unit so that the line thinning-out and double output processing unit performs switching between even-numbered horizontal line output processing and odd-numbered horizontal line output processing each time scanning of one frame is performed two times.

8. The display control apparatus according to claim 5, further comprising:
an evaluation unit configured to evaluate a correlation between a plurality of frame images obtained from the input video signal; and
a simple thinning-out/thinning-out and double output/normal output selective performance unit configured to selectively perform simple line thinning-out processing for extracting even-numbered horizontal lines or odd-numbered horizontal lines from the frame image obtained from the input video signal and outputting the extracted even-numbered horizontal lines or odd-numbered horizontal lines to the signal line driving unit, line thinning-out and double output processing for extracting even-numbered horizontal lines or odd-numbered horizontal lines from the frame image obtained from the input video signal and continuously outputting a result of the extraction two times to the signal line driving unit, and normal output processing for sequentially outputting to the signal line driving unit image signals of horizontal lines included in the frame image obtained from the input video signal, and
wherein the scanning control unit selectively performs scanning control processing in a first control mode of controlling the scanning line driving unit so that, when the combinations of four continuous frame images are set, the combinations of the plurality of simultaneously driven scanning lines are changed between display times of the first frame image and the second frame image included in each of the combinations of four continuous frame images and between display times of the third frame image and the fourth frame image, scanning control processing in a second control mode of controlling the scanning line driving unit so that the combinations of the plurality of simultaneously driven scanning lines are changed each time scanning of one frame is performed two times, and scanning control processing in a third control mode of controlling the scanning line driving unit so that the plurality of scanning lines are sequentially driven, and
wherein the display control apparatus further includes,
a fourth even/odd-numbered line output switching control unit configured to selectively perform even/odd-numbered line output switching control processing in the first control mode of controlling the simple thinning-out/thinning-out and double output/normal output selective performance unit so that the simple thinning-out/thinning-out and double output/normal output selective performance unit performs switching between even-numbered horizontal line output processing and odd-numbered horizontal line output processing between the display times of the first frame image and the second frame image and between the display times of the third frame image and the fourth frame image and even/odd-numbered line output switching control processing in the second control mode of controlling the simple thinning-out/thinning-out and double output/normal output selective performance unit so that the simple thinning-out/thinning-out and double output/normal output selective performance unit performs switching between the even-numbered horizontal line output processing and the odd-numbered horizontal line output processing each time scanning of one frame is performed two times, and
a driving mode switching instruction unit configured to transmit instructions to the simple thinning-out/thinning-out and double output/normal output selective performance unit, the scanning control unit, and the fourth even/odd-numbered line output switching control unit so that switching among a first driving mode, a second driving mode, and a normal driving mode is performed on the basis of a result of evaluation performed by the evaluation unit, the first driving mode in which the simple thinning-out/thinning-out and double output/normal output selective performance unit performs the simple line thinning-out processing, the scanning control unit performs the scanning control processing in the first control mode, and the fourth even/odd-numbered line output switching control unit performs the even/odd-numbered line output switching control processing in the first control mode, the second driving mode in which the simple thinning-out/thinning-out and double output/normal output selective performance unit performs the line thinning-out and double output processing, the scanning control unit performs the scanning control processing in the second control mode, and the fourth even/odd-numbered line output switching control unit performs the even/odd-numbered line output switching control processing in the second control mode, the normal driving mode in which the simple thinning-out/thinning-out and double output/normal output selective performance unit performs the normal output processing and the scanning control unit performs the scanning control processing in the third control mode.

9. The display control apparatus according to claim 8, further comprising an input frame rate switching processing unit configured to change a frame fate of the input video signal in the first driving mode, the second driving mode, and the normal driving mode.

10. The display control apparatus according to claim 9,
wherein, when the frame rate of the input video signal is set to a frame rate for the first driving mode, the input frame rate switching processing unit does not change the frame rate of the input video signal in the first driving mode, reduces the frame rate of the input video signal by half by calculating an average of signal values of two continuous frame images obtained from the input video signal so as to combine the two continuous frame images into one frame in the second driving mode, and reduces the frame rate of the input video signal by one-fourth by calculating an average of signal values of four continuous frame images obtained from the input video signal so as to combine the four continuous frame images into one frame in the normal driving mode.

11. The display control apparatus according to claim 1, further comprising the evaluation unit configured to evaluate a correlation between a plurality of frame images obtained from the input video signal, and
wherein the scanning control unit selectively performs scanning control processing in a multiple-line simultaneous driving mode of controlling the scanning line driving unit so that a plurality of adjacent scanning lines are simultaneously driven in the horizontal line period in which an image signal of one horizontal line is output for display and the combinations of the plurality of simultaneously driven scanning lines are changed in each period corresponding to a frame period and scanning control processing in the normal driving mode of controlling the scanning line driving unit so that the plurality of scanning lines are sequentially driven, and
wherein the display control apparatus further includes the driving mode switching instruction unit configured to transmit an instruction to the scanning control unit so that switching between the scanning control processing in the multiple-line simultaneous driving mode and the scanning control processing in the normal driving mode is performed on the basis of a result of evaluation performed by the evaluation unit.

12. A display control method of controlling a display panel unit including a display unit having a plurality of scanning lines and a plurality of signal lines, a scanning line driving unit for selecting a horizontal line into which signals are written at the time of driving the plurality of signal lines by driving one of the plurality of scanning lines included in the display unit, and a signal line driving unit for causing the display unit to display an image by driving the plurality of signal lines on the basis of an input image signal, the display control method comprising the steps of:
controlling the scanning line driving unit so that a plurality of adjacent scanning lines are simultaneously driven in a horizontal line period in which an image signal of one horizontal line is output for display and the same pixel value is written into a plurality of adjacent pixels; and
controlling the scanning line driving unit so that combinations of a plurality of simultaneously driven scanning lines are changed in each period corresponding to a frame period.
